(19) United States
(12) Patent Application Publication
(10) Pub. No.: US 2024/0418847 A1
(43) Pub. Date: Dec. 19, 2024

(54) METHOD FOR ESTIMATING POSITION OF TARGET OBJECT, NON-TRANSITORY COMPUTER READABLE STORAGE MEDIUM, AND TARGET OBJECT POSITION ESTIMATION DEVICE

(71) Applicants: DENSO CORPORATION, Kariya-city (JP); TOYOTA JIDOSHA KABUSHIKI KAISHA, Toyota-shi (JP); MIRISE Technologies Corporation, Nisshin-shi (JP)

(72) Inventor: Atsushi KITAYAMA, Nisshin-shi (JP)

(21) Appl. No.: 18/739,771

(22) Filed: Jun. 11, 2024

(30) Foreign Application Priority Data
Jun. 15, 2023 (JP) 2023-098261
Apr. 12, 2024 (JP) 2024-064338

(51) Int. Cl. G01S 13/42; G01S 7/35; G01S 13/58; G01S 13/86; G01S 13/931

(52) U.S. Cl. CPC G01S 13/42; G01S 7/356; G01S 13/584; G01S 13/867; G01S 13/931

(57) ABSTRACT

A target object position estimation method includes: obtaining frequency distributions representing frequency and intensity for two successive transmission waves; obtaining an intensity distribution representing an intensity on a cell of a combination of a distance relative to a position of a millimeter wave radar and a velocity; generating at least one ranging point by extracting at least one cell having a greater intensity than a predetermined threshold value in the intensity distribution; predicting a type of the target object to which the ranging point belongs; setting a change threshold value in a target area; generating a plurality of ranging points representing positions relative to the position of the millimeter wave radar based on a plurality of cells extracted from the target area and representing greater intensities than the change threshold value; and estimating the position of the target object relative to the position of the millimeter wave radar.

### CROSS REFERENCE TO RELATED APPLICATIONS

The present application claims the benefit of priority from Japanese Patent Application No. 2023-98261 filed on Jun. 15, 2023 and Japanese Patent Application No. 2024-64338 filed on Apr. 12, 2024, and the entire disclosures of the above application are incorporated herein by reference.

### TECHNICAL FIELD

The present disclosure relates to a method for estimating a position of a target object, a non-transitory computer readable storage medium for executing the method by a computer, and a target object position estimation device.

### BACKGROUND

As a method for identifying a target, for example, it has been known to detect a target using a frequency modulated continuous wave (FMCW) radar device and to obtain attribute information of the target, such as type, material, or size, using a camera, thereby to identify the target.

### SUMMARY

The present disclosure provides a method for estimating a position of a target object, a non-transitory computer readable storage medium for executing the method by a computer, and a target position estimation device.

### BRIEF DESCRIPTION OF THE DRAWINGS

Objects, features and advantages of the present disclosure will become more apparent from the following detailed description made with reference to the accompanying drawings, in which:

FIG. 1 is a diagram showing a vehicle on which a target object position estimation device according to a first embodiment is mounted;

FIG. 2 is a diagram illustrating the target object position estimation device;

FIG. 3 is a block diagram illustrating a signal processing unit and a central processing unit;

FIG. 4 is a diagram illustrating an example of intensity distribution;

FIG. 5 is a diagram illustrating a two-dimensional constant false alarm rate processing;

FIG. 6 is a diagram illustrating cells extracted by the constant false alarm rate processing;

FIG. 7 is a diagram illustrating a distribution representing a distance and an intensity of each cell, in the intensity distribution in FIG. 4, at the velocity of 0 Km/h relative to a millimeter wave radar;

FIG. 8 is a diagram illustrating cells extracted by setting a change threshold value;

FIG. 9 is a flow chart illustrating an example of a method for estimating a position of a target object;

FIG. 10 is a diagram illustrating positions of ranging points relative to the millimeter wave radar;

FIG. 11 is a diagram illustrating cells extracted by the setting of the change threshold value;

FIG. 12 is a diagram illustrating a ranging point cloud generated by a second detection process;

FIG. 13 is an explanatory diagram illustrating, for each type of target, a received power of a reflection wave with respect to a distance to the target;

FIG. 14 is an explanatory diagram illustrating distributions of received powers of reflection waves from a vehicle and a road surface with an inclination of −15 degrees;

FIG. 15 is an explanatory diagram illustrating a change in radar cross section with respect to the inclination of the road surface;

FIG. 16 is an explanatory diagram illustrating an example of a definition table;

FIG. 17 is an explanatory diagram illustrating a method for determining a radar cross section σ2;

FIG. 18 is an explanatory diagram illustrating the method for determining the radar cross section σ2;

FIG. 19 is a flowchart illustrating an example of a method for estimating a position of a target object according to a second embodiment;

FIG. 20 is an explanatory diagram illustrating a set change threshold value;

FIG. 21 is a diagram illustrating the advantages of a method for setting the change threshold value according to the second embodiment; and

FIGS. 22A and 22B are explanatory diagrams illustrating the advantage achieved by considering the inclination of a road surface.

### DETAILED DESCRIPTION

As a method for identifying a target, for example, it has been known to detect a target using a frequency modulated continuous wave (FMCW) radar device and to obtain attribute information of the target, such as type, material, or size, using a camera, thereby to identify the target. In this target identifying method, it is determined whether or not the position of the target in a current processing cycle matches the position of the target in a previous processing cycle, based on the position and attribute information of the target in the previous processing cycle acquired by using the camera. When the position of the target in the current processing cycle matches the position of the target in the previous processing cycle, a prediction frequency, which is the frequency at which a peak is likely to exist in measurement of the current processing cycle, is calculated. Then, an extraction threshold value for frequency components near the prediction frequency is changed based on the attributes.

When the target is a vehicle, the extraction threshold value is set to be high in a frequency region in which the peak based on a reflected wave from the vehicle is expected to be detected. This makes it possible to restrict extraction of unnecessary peaks, which are generated due to noise. When the target is a non-vehicle, the extraction threshold value is set to be low in a frequency region in which the peak based on a reflected wave from the non-vehicle is expected to be detected. Even if the signal intensity of the reflected wave is low, the peak to be extracted can be extracted reliably.

In the target identifying method described above, when the position of the recognized target in the previous processing cycle does not match the position of the target specified from target object information, the processing is terminated. Therefore, there is a demand of a target detection that is not affected by the change in position of the target.

The present disclosure can be realized as in the following embodiments.

According to an aspect of the present disclosure, a method for estimating a position of a target object is provided. This method for estimating a position of a target object includes: a first frequency processing process of obtaining frequency distributions each representing a frequency and an intensity for at least two successive transmission waves by performing FFT on digital signals, the digital signals being obtained based on reception signals caused by receiving reflected waves of modulated transmission waves transmitted from a millimeter wave radar and reflected by a target object; a second frequency processing process of obtaining an intensity distribution representing an intensity on a cell of a combination of a distance relative to a position of the millimeter wave radar and a velocity by performing a Doppler FFT on at least two frequency distributions corresponding to the at least two successive transmission waves; a first detecting process of generating at least one ranging point representing a position relative to the position of the millimeter wave radar, based on at least one cell extracted from the intensity distribution and having an intensity greater than a predetermined threshold value; a predicting process of predicting a type of the target object to which the ranging point belongs based on an image data including the target object and obtained by an image generation device; a threshold changing process of setting a change threshold value, for the at least one cell extracted, in a predetermined target area having a range that includes the cell of the intensity distribution and is determined based on the predicted type of the target object; a second detecting process of generating a plurality of ranging points representing positions relative to the position of the millimeter wave radar, based on a plurality of cells extracted in the target area and representing intensities greater than the change threshold value; and a target object position estimating process of estimating the position of the target object relative to the position of the millimeter wave radar based on the plurality of ranging points.

In the method for estimating the position of the target object according to the aspect, the change threshold value is set in the target area having the range that is determined based on the predicted type of the target object. Therefore, the position of the target object can be estimated accurately, as compared to a method in which a change threshold value is set based on the predicted position of the target object. In addition, by estimating one or more of the size, type, orientation, and speed of the target object, the position of the target object can be estimated accurately, as compared with a method in which these are not estimated.

According to another aspect of the present disclosure, an object position estimation device is provided. This target object position estimation device, which is a millimeter wave radar that transmits a modulated transmission wave, includes: an arithmetic processing unit configured to obtain frequency distributions each representing a frequency and an intensity for at least two successive transmission waves by performing FFT on digital signals that are obtained based on reception signals caused by receiving reflected waves of modulated transmission waves transmitted from the millimeter wave radar and reflected by a target object, and to obtain an intensity distribution representing an intensity of a cell of a combination of a distance and a velocity relative to a position of the millimeter wave radar by performing a Doppler FFT on at least two frequency distributions corresponding to the at least two successive transmission waves; a first detection unit configured to generate at least one ranging point representing a position relative to a position of the millimeter wave radar based on the cell in the intensity distribution and having an intensity greater than a predetermined threshold value; a prediction unit configured to predict a type of the target object to which the at least one ranging point belongs based on an image data obtained by an image generation unit and including the target object; a threshold changing unit configured to set a change threshold value, for the at least one cell extracted, in a target area having a range that is determined based on the predicted type of the target object and including the cell in the intensity distribution; a second detection unit configured to extract a plurality of cells having greater intensities than the change threshold value in the target area and to generate a plurality of ranging points representing positions relative to the position of the millimeter wave radar based on the plurality of cells; and a position estimation unit configured to estimate the position of the target object relative to the position of the millimeter wave radar based on the plurality of ranging points.

Multiple embodiments of the present disclosure will be described with reference to the drawings.

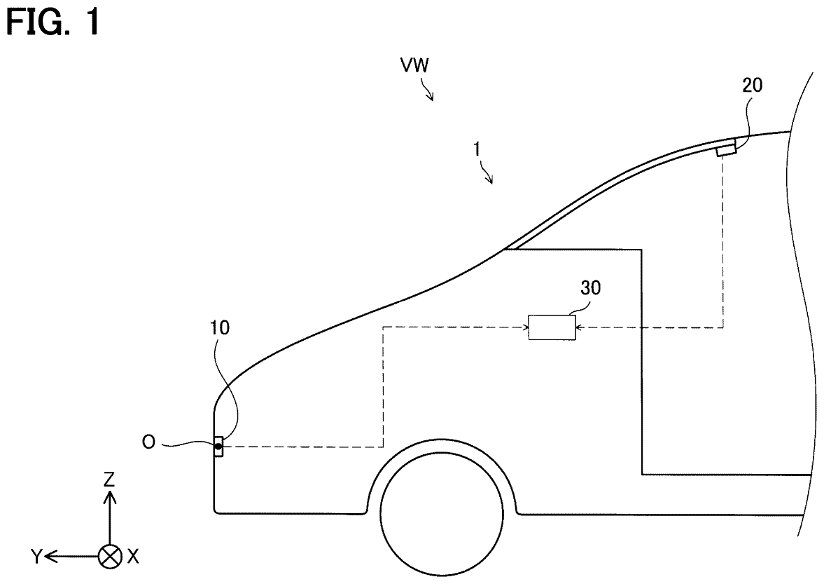

A. First Embodiment: A1. Configuration of First Embodiment: A target object position estimation device 1 shown in FIG. 1 estimates the position of a target object therearound. In the present embodiment, the target object position estimation device 1 is installed in a vehicle VW as shown in FIG. 1, and estimates the position of a target object around the vehicle VW. In the present embodiment, the target object position estimation device 1 estimates the size, type, direction of travel, velocity, or the like of the target object, in addition to the position of the target object. In FIG. 1, a front and rear direction of the vehicle VW is indicated along an Y axis, a direction along the width of the vehicle VW while passing through an origin O is indicated along an X axis, and a vertical direction passing through the origin O is indicated along a Z axis. In order to make the drawing easier to see, the axes are shown at a position that do not pass through the origin O. The forward direction of the vehicle VW is defined as a +Y direction, the rightward direction of the vehicle VW is defined as a +X direction, and the vertical direction is defined as a +Z direction. The origin O will be explained later. As shown in FIG. 1, the target object position estimation device 1 includes a millimeter wave radar 10, an image generation device 20, and a central processing unit 30. The millimeter wave radar 10 and the image generation device 20 are each electrically connected to the central processing unit 30, and are capable of transmitting and receiving signals and data.

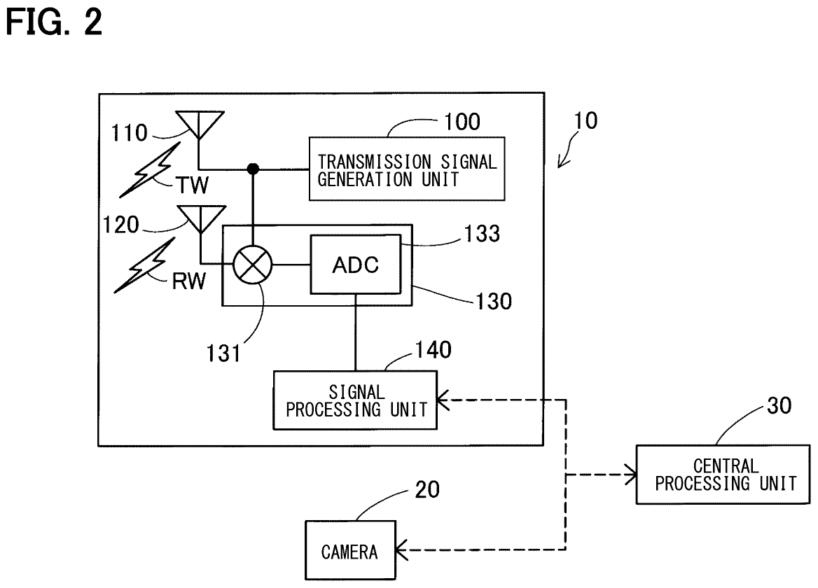

The millimeter wave radar 10 transmits and receives frequency-modulated electromagnetic waves in a millimeter wave band to recognize an object around the vehicle VW and detect the position of the object relative to the millimeter wave radar 10. In the present embodiment, the object include, for example, other vehicles, pedestrians, bicycles, buildings, plants, and the like. The same applies to a “target object” in this specification. The millimeter wave radar 10 repeatedly transmits electromagnetic waves at regular time intervals. As shown in FIG. 2, the millimeter wave radar 10 includes a transmission signal generation unit 100, a transmitter 110, a receiver 120, a digital signal generation unit 130, and a signal processing unit 140.

The transmission signal generation unit 100 generates a modulated electromagnetic wave in the millimeter wave band. Specifically, the transmission signal generation unit 100 generates a transmission signal that is a chirp signal whose frequency is linear with respect to time. The transmitter 110 emits the transmission signal into space as the electromagnetic wave. Hereinafter, the electromagnetic wave transmitted as the transmission signal will be referred to as the “transmission wave TW”. In the following description, the position from which the transmission wave TW is emitted will be referred to as “origin O” as shown in FIG. 1. The transmitter 110 shown in FIG. 2 is an antenna. The area to which the transmitter 110 can transmit the transmission wave TW is an area that encompasses objects present around the vehicle VW, and that includes the front, sides, and diagonally rear of the vehicle VW shown in FIG. 1. The receiver 120 shown in FIG. 2 receives, as a reception signal, an electromagnetic wave generated due to the transmission wave TW being reflected by an object. In the following description, the electromagnetic wave reflected by an object is referred to as the “reflected wave RW”. The receiver 120 is an antenna.

The digital signal generation unit 130 generates a digital signal based on the reception signal. The digital signal generation unit 130 includes a mixer 131, a filter (not shown), and an analog-to-digital converter (ADC) 133. The mixer 131 mixes the reception signal and the transmission signal to output a beat signal indicated as a complex signal in time domain. The filter attenuates high frequency components in the signal output from the mixer 131 to suppress aliasing in the analog-to-digital converter 133. The analog-to-digital converter 133 converts the signal processed by the filter into a digital signal in the time domain and outputs the digital signal.

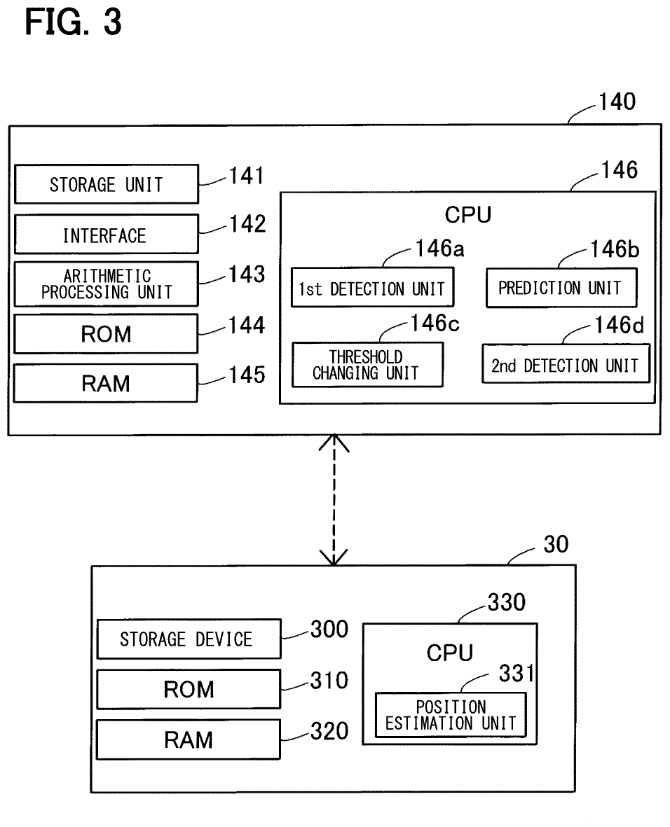

The signal processing unit 140 performs processing of generating information on an object that has reflected the transmission wave TW, based on the digital signal output from the analog-to-digital converter 133. As shown in FIG. 3, the signal processing unit 140 is configured as a computer including a storage unit 141, an interface 142, an arithmetic processing unit 143, a ROM 144, a RAM 145, and a CPU 146. The storage unit 141 stores information on position relative to the millimeter wave radar 10, velocity, intensity of the received power of the reflected wave RW and the like of each of a plurality of ranging points APF generated by the CPU 146. The ranging point APF is a point that indicates the position relative to the position of the millimeter wave radar 10 as a reference. More specifically, the ranging point APF is a point that indicates a position where at least a part of an object identified by the reflected wave RW would be present within the range where the target object position estimation device 1 can measure the distance. The generation of the ranging points APF will be described later. The interface 142 inputs and outputs signals from and to the outside.

The arithmetic processing unit 143 performs processing, such as fast Fourier transform (FFT), doppler FFT, and constant false alarm rate (CFAR). First, the FFT will be described. In the FFT processing, the arithmetic processing unit 143 converts a time domain digital signal, which is obtained based on the reception signal acquired by receiving the reflected wave RW, into a frequency domain digital signal to obtain a frequency distribution representing the frequency and signal intensity. The arithmetic processing unit 143 can calculate, from the frequency distribution, a distance between the part of the object at which the transmission wave TW is reflected and the millimeter wave radar 10. The arithmetic processing unit 143 obtains the frequency distributions for at least two successive transmission waves TW. In the present embodiment, since the transmission waves TW are repeatedly transmitted at the regular time intervals as described above, two or more frequency distributions can be at least generated correspondingly to the two or more transmission waves TW. In the present embodiment, the arithmetic processing unit 143 generates the frequency distributions for the transmission waves TW transmitted from the start to the end of the travel of the vehicle VW.

The arithmetic processing unit 143 performs the doppler FFT processing on at least two frequency distributions corresponding to at least two successive transmission waves TW. Specifically, the arithmetic processing unit 143 can obtain information on the velocity of the part of the object at which the transmission wave TW is reflected by performing further the FFT processing on the output of each FFT processing of the repeated transmission waves TW. As a result, the arithmetic processing unit 143 obtains an intensity distribution, which is a distribution showing the intensity on cells that are combinations of the distance relative to the position of the millimeter wave radar 10 and the velocity.

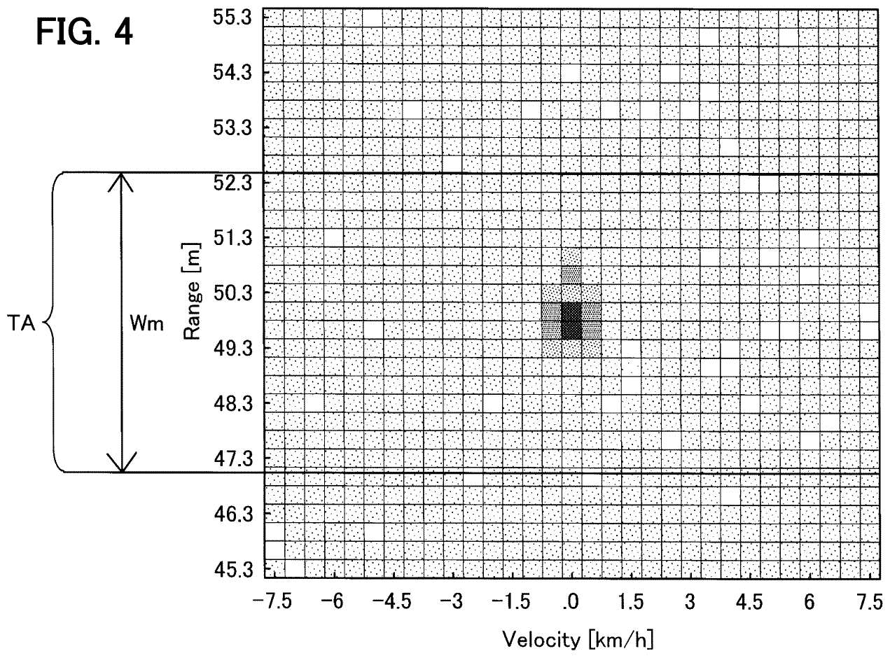

FIG. 4 shows an intensity distribution that is obtained in a method for estimating the position of a target object, which will be described later. However, the intensity distribution will be explained herein using FIG. 4 as an example. The horizontal axis of FIG. 4 represents a relative velocity of cells with respect to the millimeter wave radar 10. The vertical axis of FIG. 4 represents the distance of cells relative to the position of the millimeter wave radar 10. In the present embodiment, a cell has a size of 33 cm in the direction along the distance, and a size of 0.5 km/h in the direction along the velocity. The size of the cell can be changed in the direction along the distance and the direction along the velocity according to the waveform of the transmission wave. The size of the cell can be changed in a range from 3.3 cm to 330 cm in the direction along the distance and in a range from 0.05 km/h to 5 km/h in the direction along the velocity. As shown in FIG. 4, each cell shows the intensity of power of the reception signal. The intensity increases in proportion to the darkness of the hatching applied to the cell. In the intensity distribution of FIG. 4, the intensity is the largest in the cells that are located at the relative velocity of 0 Km/h and the distance of approximately 50 m.

The arithmetic processing unit 143 performs the constant false alarm rate processing on the intensities of the intensity distribution to extract the cell having the intensity larger than a predetermined threshold value. The constant false alarm rate processing is a method for detecting a target object by setting the threshold value so that a false alarm rate, which is a rate in which unwanted noise caused by reflection from rain, snow, or the like will be mistakenly detected as the target object, becomes a constant value. In the present embodiment, the threshold value is determined so that living objects, such as pedestrians and animals, and inanimate objects, such as other vehicles, buildings, and traffic lights, can be both detected.

In the present embodiment, a two-dimensional constant false alarm rate processing is performed. The two-dimensional constant false alarm rate processing will be described below. First, the arithmetic processing unit 143 calculates a first threshold value according to the following mathematical formulas 1 and 2.

$$\begin{matrix}[ Mathematical Formula 1 ] & \\ & \end{matrix}$$

$$\begin{matrix}[ Math . 1 ] & \\ α = {N}_{TC} ( {P}_{fa}^{- \frac{1}{{N}_{TC}}} - 1 ) & ( 1 )\end{matrix}$$

$$\begin{matrix}[ Mathematical Formula 2 ] & \\ & \end{matrix}$$

$$\begin{matrix}[ Math . 2 ] & \\ Threshold [ dB ] = 10 {log}_{10} α & ( 2 )\end{matrix}$$

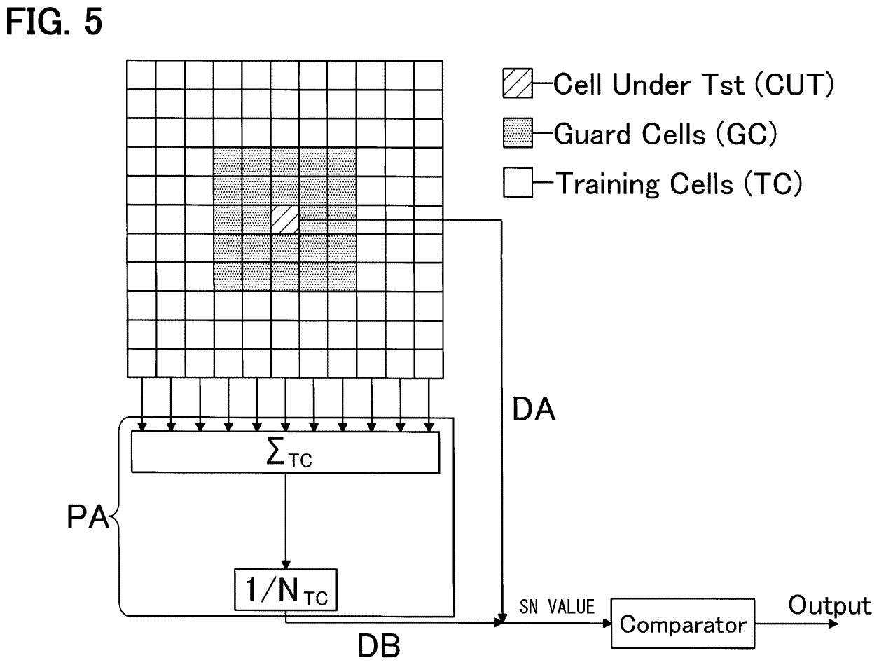

In the mathematical formula 1, Pfa represents a false alarm rate and is determined in advance. In the present embodiment, the false alarm rate is 10⁻⁵. NTc represents the total number of cells TC (TC: training cells) shown in FIG. 5. The cells TC are the remaining cells other than the several cells GC (GC: guard cells) around the test cell CUT (CUT: cell under test). In the mathematical formula 2, “Threshold” is the first threshold value.

Next, as shown in process PA of FIG. 5, the average intensity of the region of the cells TC is calculated. The test cell CUT is a cell whose intensity is being determined whether to be higher than the first threshold value or not by the arithmetic processing unit 143. In FIG. 5, the test cell CUT is the cell located in the center. The number of cells GC around the test cell CUT can be changed. The section size of each cell shown in FIG. 5 is the same as that of the cell shown in FIG. 4. The arithmetic processing unit 143 calculates the SN value using the following mathematical formula 3 from the average of the total powers of all the test cells CUT and the average of the total powers of the remaining cells TC excluding the multiple cells GC around the test cell CUT, as shown by arrows DA and DB in FIG. 5. In the present embodiment, the number of the test cell CUT is one, and the SN value is calculated from the power of the one test cell CUT and the average of the total powers of the cells TC. For example, nine cells including the test cell CUT and eight cells adjacent to the test cell CUT in FIG. 5 may be used as the test cells CUT.

$$\begin{matrix}[ Mathematical Formula 3 ] & \\ & \end{matrix}$$

$$\begin{matrix}[ Math . 3 ] & \\ SN = \frac{CUT Average Power}{TC Average Power} = \frac{Σ {P}_{C U T} / {N}_{C U T}}{Σ {P}_{T C} / {N}_{T C}} & ( 3 )\end{matrix}$$

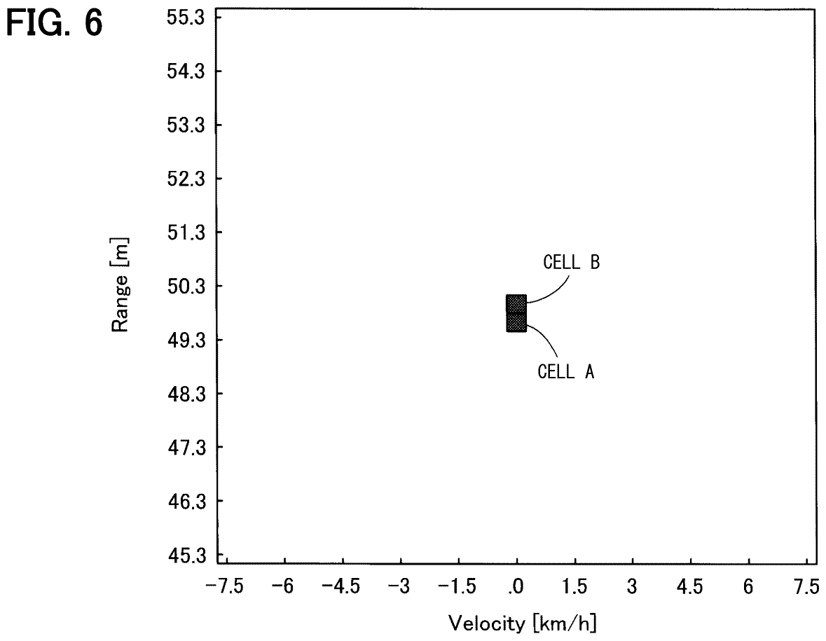

When the SN value calculated from the mathematical formula 3 is equal to or greater than the first threshold value calculated by the mathematical formula 2, the arithmetic processing unit 143 extracts the test cell CUT. The arithmetic processing unit 143 performs the above-mentioned processing on all the cells as the test cells. The arithmetic processing unit 143 performs the two-dimensional constant false alarm rate processing on the intensity distribution shown in FIG. 4 to extract the cells as shown in FIG. 6. Note that FIG. 6 shows an intensity distribution obtained in the method for estimating the position of a target object, which will be described later, but is used to explain the extracted cells, as an example.

A first power threshold value, which is the power intensity required to extract the cell, is calculated from the SN value using the following mathematical formula 4.

$$\begin{matrix}[ Mathematical Formula 4 ] & \\ & \end{matrix}$$

$$\begin{matrix}[ Math . 4 ] & \\ 1 st Power Threshold = 1 st Threshold \times TC Average Power & ( 4 )\end{matrix}$$

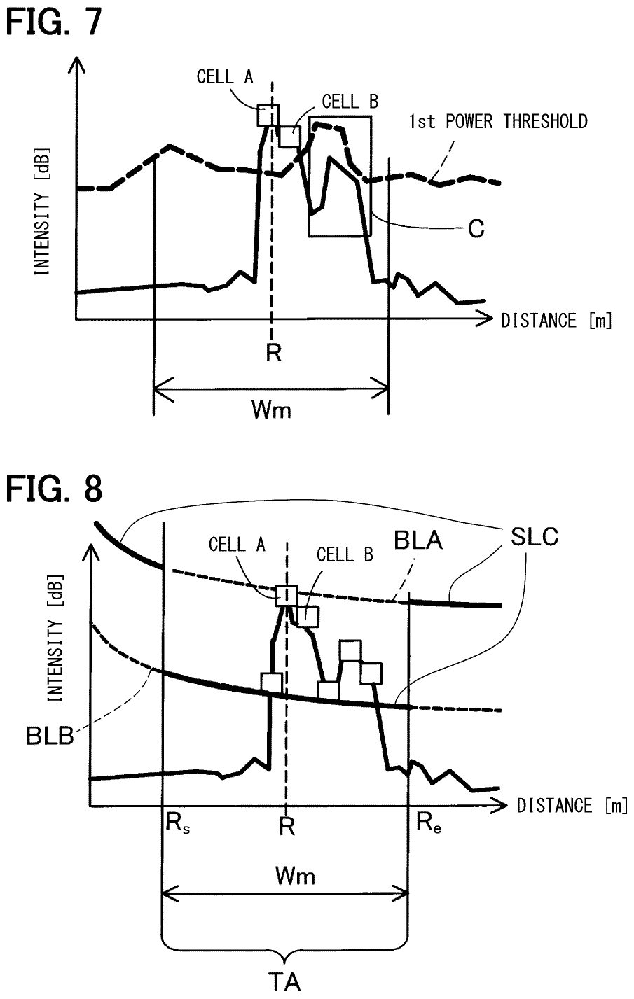

In FIG. 7, a solid line indicates connections of the cells. As shown in FIG. 7, the arithmetic processing unit 143 extracts cell A and cell B, which are cells having the intensities greater than the first power threshold value, as a predetermined threshold value. The first power threshold value is proportional to the average of the sum of the powers of the cells TC. In some cells at a greater distance than the cell B shown in FIG. 7, the powers of the cells A and B are included in the calculation of the first power threshold value of the cells TC. As a result, as shown in a solid line frame C in FIG. 7, the first power threshold value at a distance greater than the cell B is higher than the first power threshold value at the distances of the cell A and the cell B. Therefore, the cells within the solid-line frame C are difficult to extract. The arithmetic processing unit 143 performs similar processing for each cell whose velocity relative to the millimeter wave radar 10 is other than 0 km/h in the intensity distribution of FIG. 4.

The ROM 144 shown in FIG. 3 holds a program for operating the signal processing unit 140. The RAM 145 has a memory area into which the programs stored in the ROM 144 are expanded. The CPU 146 loads the programs stored in the ROM 144 onto the RAM 145 to realize various functions. In the present embodiment, the CPU 146 functions as a first detection unit 146a, a prediction unit 146b, a threshold changing unit 146c, and a second detection unit 146d.

The first detection unit 146a generates one or more ranging points APF that indicate the positions relative to the position of the millimeter wave radar 10, based on the cells having the intensities greater than the first power threshold value, which is a predetermined threshold value. The ranging point APF further indicates the velocity. In the present embodiment, the position of the ranging point APF relative to the millimeter wave radar 10 is estimated by using MUSIC, which is an orientation estimation algorithm.

The prediction unit 146b predicts the type of a target object to which the ranging point APF belongs, based on image data acquired from the image generation device 20 and including the target object. In the present embodiment, the prediction unit 146b has two methods for predicting the type of the target object. In the first method, the prediction unit 146b predicts the type of the target object based on the position of the ranging point APF relative to the position of the millimeter wave radar 10 and the image data generated by the image generation device 20. In particular, the prediction unit 146b detects an object in the image data using an object detection algorithm. Then, the prediction unit 146b matches the position of the ranging point APF relative to the position of the millimeter wave radar 10 to the image data, and predicts an object located at that position as the target object. The image data is data generated by the image generation device 20 at the same time point as the time point at which the transmission wave TW is transmitted by the transmitter 110 or at the most recent time point. The image generation device 20 will be described in detail later.

In the second method, the prediction unit 146b predicts the type of the target object estimated in the previous processing as the type of the target object to which the ranging point APF belongs, when the position of the ranging point APF relative to the millimeter wave radar 10 and the position of the target object estimated in the previous processing are closer than a predetermined distance. The prediction unit 146b sends to the central processing unit 30 a signal requesting information on the type of the target object estimated in the previous processing, and receives from the central processing unit 30 information on the type of the target object stored in the storage device 300 of the central processing unit 30. The storage device 300 will be described later. In the present embodiment, the predetermined distance is 50 cm, and the previous processing means the processing performed in the previous method for estimating the position of the target object. The method for estimating the position of the target object and which of the first method or the second method being used to predict the type of the target object will be described later.

The threshold changing unit 146c sets a change threshold value, for each ranging point APF, in a target area that has a range determined based on the predicted type of target object and including the cells of the intensity distribution. FIG. 8 shows the distribution of distance and intensity obtained in the method for estimating the position of a target object according to the present embodiment, which will be described later, but setting of the change threshold value based on cell A will be described with reference to FIG. 8. As shown in FIG. 8, the range determined based on the type of target object is the range of a dimension corresponding to the type of target object in the direction of the distance relative to the millimeter wave radar 10, centered on the center of cell A. The dimension of each type of target object is input in advance by the manufacturer to the signal processing unit 140 and stored in the storage unit 141. For example, when the type of target object is a vehicle, the average of the overall lengths of plural types of vehicles is stored in the memory unit 141 as a vehicle dimension.

First, the threshold changing unit 146c calculates, using a mathematical formula 5, a second power threshold value, which is a threshold value determined in advance according to the type of target object, as shown in FIG. 8.

$$\begin{matrix}[ Mathematical Formula 5 ] & \\ & \end{matrix}$$

$$\begin{matrix}[ Math . 5 ] & \\ {P}_{r} = \frac{{P}_{t} {G}^{2} {λ}^{2} σ}{{( 4 π )}^{3} \cdot {R}^{4}} & ( 5 )\end{matrix}$$

The mathematical formula 5 is a known theoretical formula for the received power of the millimeter wave radar. Pr represents the received power of the millimeter wave radar 10, Pt represents the peak power of the millimeter wave radar 10, G represents the antenna gain, λ represents the wavelength, σ represents the radar cross section, and R represents the distance between the target object and the millimeter wave radar 10. The radar cross section has a value that represents the magnitude of intensity of the electromagnetic wave reflected from the target object toward the receiver 120, when the radio wave is emitted from the millimeter wave radar 10 toward the target object. The radar cross section is determined in advance depending on the type of target object. The threshold changing unit 146c calculates the intensity of the received power of the reflected wave RW using the radar cross section, and sets the calculated intensity, as a second power threshold value determined in advance based on the type of target object, as represented by a dashed line BLA in FIG. 8. The unit of the radar cross section is square meters. In the present embodiment, a predetermined radar cross section in dBsm (dB square meter) is converted to square meters and applied to the mathematical formula 5. In the present embodiment, the predetermined radar cross section in dBsm depending on the type of target object is 20 dBsm when the target object is an inanimate object including a vehicle, and 0 dBsm when the target object is a living object.

Next, the threshold changing unit 146c sets the change threshold value in the target area TA using the mathematical formula 5, the target area TA having a range from point Rsm to point Rem, which forms the range Wm determined based on the type of target object and centered on the center of cell A. The radar cross section used to set the change threshold value has a value that is changed from a predetermined value depending on the type of target object. The changed value is in a range of −5 dBsm to +5 dBsm when the target object is an inanimate object including a vehicle, and in a range of −15 dBsm to −5 dBsm when the target object is a living object. In the present embodiment, the changed value is 0 dBsm when the target object is a vehicle, and is −10 dBsm when the target object is a living object. In FIG. 8, the dashed line BLB indicates the change threshold value. As shown in the mathematical formula 5, the intensity of the received power is proportional to the radar cross section. Therefore, by setting the radar cross section, which is predetermined depending on the type of target object, small, the change threshold value becomes smaller than the second power threshold value. As indicated by the solid line SLC in FIG. 8, the threshold changing unit 146c sets the threshold value in the target area TA to the calculated change threshold value, and sets the threshold value outside the target area TA to the second power threshold value.

The second detection unit 146d extracts multiple cells indicating the intensities greater than the change threshold value in the target area TA, and generates based on the extracted cells multiple ranging points APF indicating the positions relative to the position of the millimeter wave radar 10. The multiple ranging points APF indicate the velocities as well. In the distribution of FIG. 8, six cells are extracted. The cell extraction is performed for each of the cells at velocities other than 0 km/h in the intensity distribution shown in FIG. 4. In the present embodiment, the position of the cell relative to the millimeter wave radar 10 is estimated by using MUSIC, which is an orientation estimation algorithm. In the present embodiment, the second detector 146d calculates the three-dimensional position, orientation, size, and velocity of each of the ranging points APF. The three-dimensional size and velocity of each ranging point APF are determined by algorithmically clustering and tracking the ranging points.

Further, in the present embodiment, the second detection unit 146d generates a ranging point cloud RPC composed of the multiple ranging points APF, and calculates the three-dimensional position relative to the millimeter wave radar 10, orientation, size, and velocity of the ranging point cloud RPC. The ranging point cloud RPC means a collection of ranging points APF in a certain period of time, and is represented by the three-dimensional coordinates of the ranging points APF of the target object. In the certain period of time, multiple ranging point clouds RPC may be generated. The ranging point cloud RPC is generated using an algorithm for grouping the point cloud.

The image generation device 20 shown in FIG. 1 generates image data including a target object. The image generation device 20 transmits the generated image data to the central processing unit 30. In the present embodiment, the image generation device 20 generates image data successively with a predetermined time difference. In the present embodiment, the image generation device 20 is a camera.

The central processing unit 30 estimates information including the position of the target object. As shown in FIG. 3, the central processing unit 30 includes a storage device 300, a ROM 310, a RAM 320, and a CPU 330 as a processor. The storage device 300 stores information on the estimated target object. In the present embodiment, the storage device 300 stores the estimated position, size, type, orientation, and velocity of the target object. The ROM 310 holds programs for the operation of the central processing unit 30. The RAM 320 has a memory area into which the programs stored in the ROM 310 are expanded. The CPU 330 loads the programs stored in the ROM 310 onto the RAM 320 to realize various functions. In the present embodiment, the CPU 330 functions as a position estimation unit 331.

The position estimation unit 331 estimates the position of the target object relative to the position of the millimeter wave radar 10, based on the multiple ranging points APF generated by the second detection unit 146d. In the present embodiment, the position estimation unit 331 estimates the position of the target object relative to the position of the millimeter wave radar 10, based on the ranging point cloud RPC composed of the multiple ranging points APF generated by the second detection unit 146d. Specifically, the position estimation unit 331 estimates the target object and its position based on the position of the ranging point cloud RPC and the image data including the target object and acquired by the image generation device 20. Further, in the present embodiment, the position estimation unit 331 estimates the size, type, orientation, and velocity of the target object based on the estimated position of the target object and the image data. The position estimation unit 331 estimates information on the target object using an algorithm that is any one of or a combination of two or more of clustering, tracking processing, HOG, and SIFT, or an algorithm based on a machine learning.

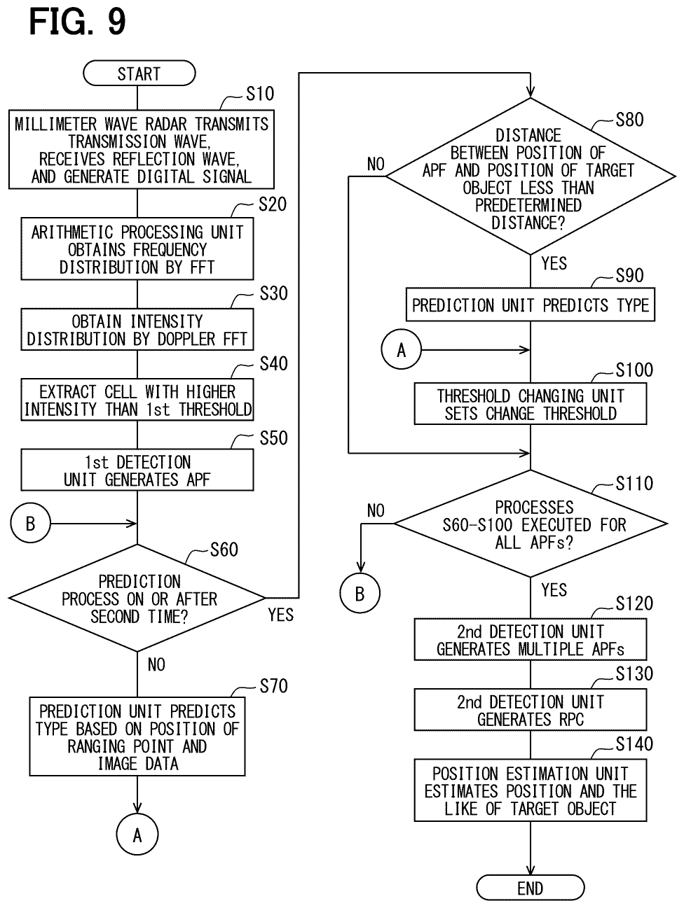

A2. Method for Estimating Position of Target Object: As a premise, before the processing shown in FIG. 9 is started, the power supply of the vehicle VW is turned on by a user and the vehicle VW starts traveling. In step S10 of FIG. 9, the millimeter wave radar 10 transmits the modulated transmission wave TW to the periphery of the vehicle VW, and obtains the digital signal based on the signal obtained by receiving the reflected wave RW caused by the transmission wave TW being reflected by a target object. Specifically, in the millimeter wave radar 10, the transmission signal generation unit 100 first generates the transmission signal, and the transmitter 110 successively radiates transmission waves TW. The receiver 120 receives the reflected waves RW as reception signals, and transmits the reception signals to the digital signal generation unit 130. Then, the digital signal generation unit 130 generates the digital signals based on the reception signals. After the power supply of the vehicle VW is turned on, the image generation device 20 generates image data successively at predetermined time intervals. In the present embodiment, the predetermined time is 1 second.

In step S20, the arithmetic processing unit 143 of the signal processing unit 140 performs the FFT on the digital signals to obtain the frequency distributions, which are distributions indicating frequency and intensity, for at least two successive transmission waves TW. The processing of step S10 and step S20 are also collectively referred to as a “first frequency processing process”.

In step S30, the arithmetic processing unit 143 performs the Doppler FFT on at least two frequency distributions corresponding to at least two successive transmission waves TW. In the present embodiment, the Doppler FFT is performed on two frequency distributions corresponding to two successive transmission waves TW. As a result, as shown in FIG. 4, the intensity distribution, which is the distribution indicating the intensity on the cells represented by the combinations of the distance and the velocity relative to the position of the millimeter wave radar 10, is obtained. The processing of step S30 is also referred to as a “second frequency processing process”.

In step S40 of FIG. 9, the arithmetic processing unit 143 extracts the cells having the intensities greater than the first threshold value, which is a predetermined threshold value, from the intensity distribution in FIG. 4. In the present embodiment, as shown in FIGS. 6 and 7, two cells A and B having the greater intensities than the first threshold value are extracted by performing the constant false alarm rate processing described above. If no cell is extracted in step S40, the processing ends.

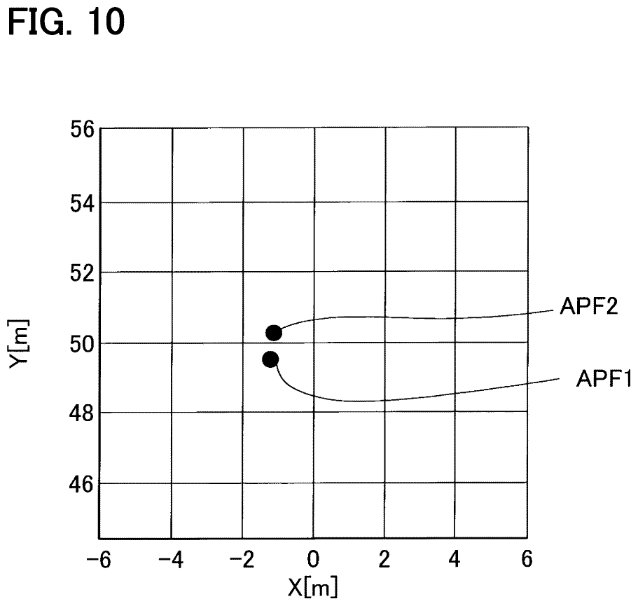

In step S50 of FIG. 9, the first detection unit 146a generates two ranging points APF, each indicting the position relative to the position of the millimeter wave radar 10, based on the extracted cell A and cell B, respectively. As shown in FIGS. 4 and 6, the intensity distribution indicates the distance of each of the cells A and B relative to the millimeter wave radar 10, but does not indicate the position of each of the cells A and B relative to the millimeter wave radar 10. As shown in FIG. 10, the generated ranging points APF indicate the positions relative to the millimeter wave radar 10. In FIG. 10, the horizontal axis represents the distance in the left-right direction with respect to the origin O of the millimeter wave radar 10 as a reference, and the vertical axis represents the distance in the forward direction from the origin O of the millimeter wave radar 10 as a reference. In FIG. 10, a first ranging point APF1 is the ranging point APF based on the cell A, and a second ranging point APF2 is the ranging point APF based on the cell B. In step S50 of FIG. 9, the storage unit 141 of the signal processing unit 140 stores the position relative to the millimeter wave radar 10, the velocity and the intensity of the received power of the reflected wave RW of the ranging point APF. The processing in step S40 and step S50 are also referred to as a “first detection process”.

In a case where one cell indicated in the intensity distribution is based on multiple reflected signals reflected at multiple positions having the same distance from the millimeter wave radar 10, the first detection unit 146a generates multiple ranging points APF based on the one cell. The multiple ranging points APF have the information on the positions, and thus can be distinguished from one another.

In step S60 of FIG. 9, the prediction unit 146b determines whether or not the prediction process to be performed is on a second or subsequent time. The prediction process refers to a process of predicting the type of the target object to which the ranging point APF belongs based on the image data that is obtained by the image generation device 20 and includes the target object. In the present embodiment, the prediction process refers to the processing from step S60 to step S90, which will be described later. The number of times of the prediction processes is counted from the start of the method for estimating the position of the target object by the object position estimation device 1. When the power supply of the vehicle VW is turned off by the user, the number of times of the prediction processes is reset. When the prediction unit 146b determines that the prediction process to be performed is not on the second or subsequent time, that is, when the prediction unit 146b determines that the prediction process to be performed is on the first time since the power supply of the vehicle VW has been turned on by the user, the processing proceeds to step S70. When the prediction unit 146b determines that the prediction process to be performed is on the second or subsequent time, the processing proceeds to step S80.

In step S70, the prediction unit 146b performs the prediction process on the first time. In the prediction process performed on the first time, the prediction unit 146b performs the first method described above. That is, as the first method, the prediction unit 146b predicts the type of target object based on the position of the ranging point APF relative to the position of the millimeter wave radar 10 and the image data generated by the image generation device 20. Then, the processing proceeds to step S100. The step S100 will be explained later. In step S60, one of the generated first ranging point APF1 and second ranging point APF2 is processed. The other ranging point APF is processed after step S110, which will be described later.

In step S80, the prediction unit 146b performs the prediction process on the second or subsequent time. The prediction process performed on the second or subsequent time means that the processing from step S10 to step S140, which will be described later, has been performed at least once since the power supply of the vehicle VW was turned on by the user. In the prediction process performed on the second time, the prediction unit 146b executes the second method described above. First, the prediction unit 146b determines whether the position of the ranging point APF relative to the position of the millimeter wave radar 10 and the position of the target object estimated in a previous processing are located closer to each other in a predetermined distance. In step S80, one of the generated first ranging point APF1 and second ranging point APF2 is processed. The other ranging APF is processed after step S110, which will be described later.

When the position of the ranging point APF relative to the position of the millimeter wave radar 10 and the position of the target object estimated in the previous processing are located closer to each other in the predetermined distance, the processing proceeds to step S90. In the present embodiment, the distance between the position of the ranging point APF relative to the position of the millimeter wave radar 10 and the position of the part of the target object that is closest to the ranging point APF is used. Depending on the timing at which the ranging point APF is generated, the position of the ranging point APF may overlap with the position of the target object, and the distance between the position of the ranging point APF and the position of the part of the target object that is closest to the position of the ranging point APF may be zero. When the position of the ranging point APF relative to the position of the millimeter wave radar 10 and the position of the target object estimated in the previous processing are not closer than the predetermined distance, the processing proceeds to step S110.

In step S90, the prediction unit 146b predicts the type of the target object estimated in the previous processing as the type of the target object to which the ranging point APF belongs. In the present embodiment, the type of the target object predicted by the prediction unit 146b is a vehicle VW. Note that, in the previous processing, when multiple target objects were estimated and two or more of them were located closer than the predetermined distance from the position of the ranging point APF, the prediction unit 146b predicts the type of the target object located closest as the type of target object to which the ranging point APF belongs.

In step S100, the threshold modification unit 146c sets the change threshold value in the target area having the range determined based on the predicted type of the target object including the cell of the intensity distribution in FIG. 4, based on the predicted type of the target object. As shown in FIG. 8, the change threshold value is set in the target area TA having the range Wm that is determined for the vehicle VW and centers the point of a distance R m at the center of the cell A relative to the millimeter wave radar 10. As shown in FIG. 4, the target area TA includes cells having different relative velocities to the millimeter wave radar 10. The processing of step S100 is also referred to as a “threshold changing process.”

In step S110, the prediction unit 146b determines whether the processing from step S60 to step S100 has been executed for each of the one or more cells extracted in the first detection process. When the processing from step S60 to step S100 has been executed for all the cells extracted in the first detection process, the processing proceeds to step S120. When the processing from step S60 to step S100 has not been executed for all the cells, the processing returns to step S60. Then, the processing from step S60 to step S100 is executed for the cells for which the processing from step S60 to step S100 has not been executed. In the present embodiment, the processing returns to step S80 at least once.

After the processing flow moves from step S110 to step S60 again, it may proceed to the same processing as the previous processing of the ranging point APF without determining whether or not the prediction process is on the second or subsequent time. In other words, when it is determined in step S60 that the prediction process to be performed is on the second or subsequent time and the processing flow proceeds to step S60 again via step S80, the processing flow may proceed to step S80 without performing the processing of step S60, so that the processing of the other ranging point APF is performed.

As a result of repeating the processing of step S80, when the prediction unit 146b determines that the positions of all ranging points APF and the position of the target object estimated in the previous processing are not closer than the predetermined distance, the processing ends.

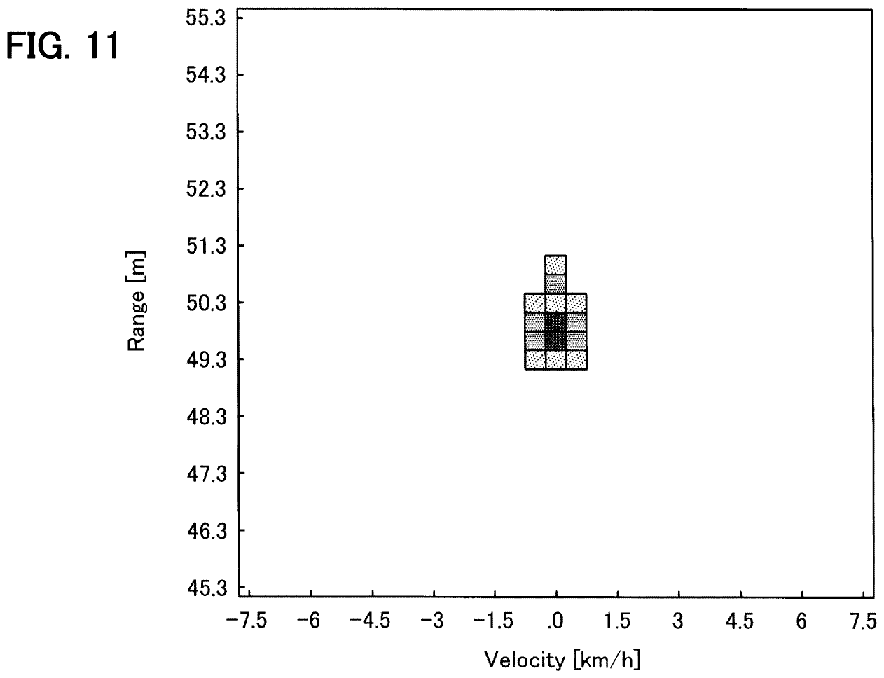

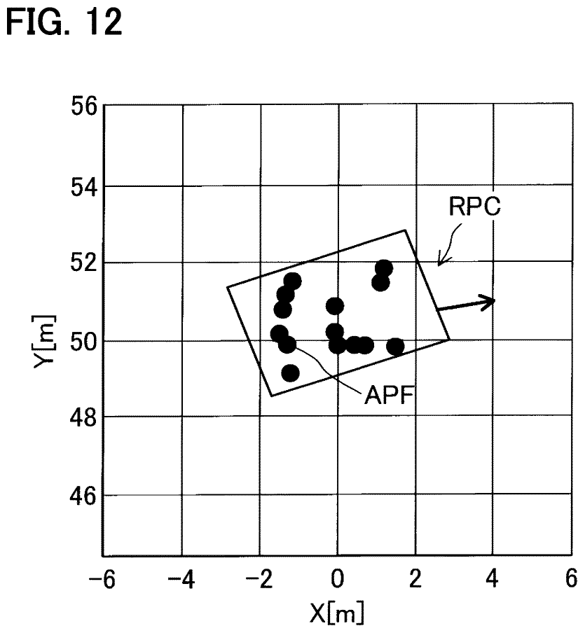

In step S120, the second detection unit 146d extracts multiple cells indicating the greater intensities than the change threshold value in the target area TA. In step S120, multiple cells indicating the greater intensities than the change threshold value set for each of the cells A and cell B are extracted. When the number of cells extracted at this time is the same as the number of cells extracted in the first detection process, the processing proceeds to step S140, which will be described later. In the present embodiment, as shown in FIG. 11, a larger number of cells are extracted than the number of cells extracted in the first detection process. As shown in FIG. 12, the second detection unit 146d generates multiple ranging points APF, each of which indicates the position relative to the position of the millimeter wave radar 10, based on the multiple extracted cells. In step S120, the storage unit 141 stores information on the position relative to the millimeter wave radar 10, the speed, and the intensity of the received power of the reflected wave RW of each of the multiple ranging points APF.

In step S130, the second detection unit 146d generates a ranging point cloud RPC from the generated ranging points APF, as shown in FIG. 12. In FIG. 12, the ranging point cloud RPC is enclosed in a solid line box, and the orientation of the ranging point cloud RPC is indicated by a solid line arrow. Although the ranging point cloud RPC is shown two-dimensionally in FIG. 12, the position estimation unit 331 generates the ranging point cloud RPC in three-dimension including the height with respect to the millimeter wave radar 10. Further, the storage unit 141 stores one or more of the three-dimensional position, orientation, size, and velocity of the ranging point cloud RPC. In the present embodiment, the storage unit 141 stores all of the three-dimensional position, orientation, size, and velocity of the ranging point cloud RPC. The processing of step S120 and step S130 are also referred to as a “second detection process”.

In step S140, the position estimation unit 331 estimates the position of the target object relative to the position of the millimeter wave radar 10, based on the multiple ranging points APF. Specifically, the position estimation unit 331 estimates the target object and the position of the target object based on the generated ranging point cloud RPC and the image data. In the present embodiment, the position estimation unit 331 further estimates the size, type, orientation, and velocity of the target object. Moreover, the storage device 300 stores the estimated information on the target object. The processing of step S140 is also referred to as a “target object position estimation process”. The processing then ends. The processing from step S10 to step S140 is repeated at regular intervals until the power supply of the vehicle VW is turned off by the user. In the present embodiment, the regular interval is 3 seconds.

In the object position estimation process, it is determined that the target object is present within a predetermined distance relative to the millimeter wave radar 10, for example, the central processing unit 30 sends a signal to a control unit (not shown) of the vehicle VW to stop the vehicle VW. The control unit that has received the signal outputs information to stop the vehicle VW by voice, image display on a monitor, or the like.

In the present embodiment, the change threshold value is set in the target area TA having the range determined based on the type of predicted target object. Therefore, the position of the target object can be estimated accurately, for example, as compared to a configuration in which the change threshold value is set based on the predicted position of the target object. In addition, since one or more of the size, type, orientation, and velocity of the target object are estimated, the position of the target object can be estimated accurately, as compared to a configuration in which these are not estimated.

The extraction of the cell of the intensity distribution by the constant false alarm rate processing is affected by the power of the surrounding cells. If the power of the cells TC surrounding the test cell CUT is large, there is a possibility that the test cell CUT will not be extracted. In the present embodiment, since the change threshold value is set in the target area TA, it is possible to extract cells without being affected by the power of the surrounding cells.

B. Second embodiment: In a second embodiment, configurations different from the first embodiment will be mainly described. Description of configurations similar to those of the first embodiment will not be repeated.

In the first embodiment described above, the influence of the reflected waves from the road surface is not taken into consideration in the detection of a target. If the road surface is flat, it is considered that the received power of the reflected wave RW on the road surface is very small. However, if there is a slope ahead on the road on which the vehicle VW is traveling, there is a risk that erroneous detection of a target will increase due to the reflected waves RW reflected by the slope of the road surface.

For this reason, in the second embodiment, the second power threshold value is set using a corrected radar cross section, which is a radar cross section considering the inclination of the road surface. In the configuration according to the present embodiment, the inclination of the road surface is considered in the detection of a target, so that the occurrence of erroneous detection of a target can be suppressed.

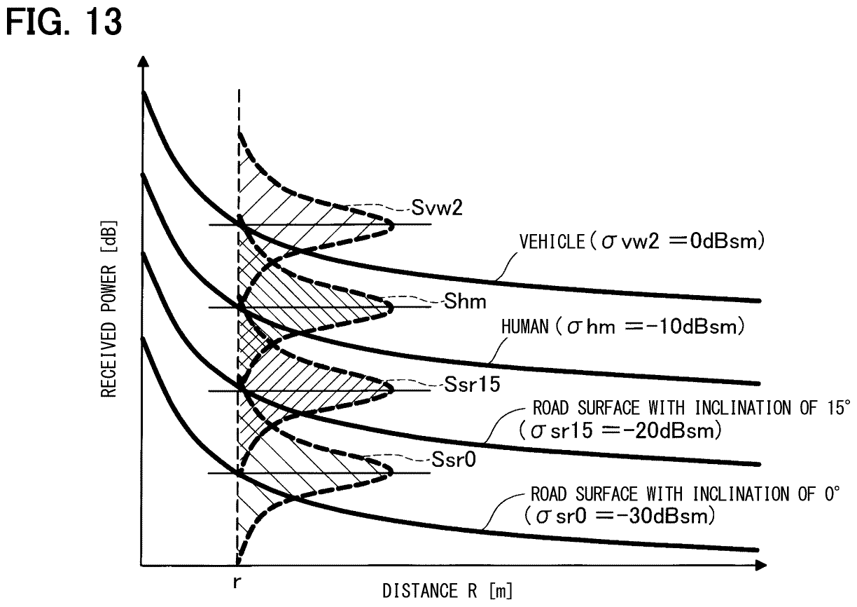

FIG. 13 shows the received power of the reflected wave RW according to the distance R to the target for each type of the target. In FIG. 13, solid lines indicate the received powers of the reflected waves from a vehicle, a human, a road surface with an inclination of 15 degrees, and a road surface with an inclination of 0 degrees, as targets.

In FIG. 13, a hatched region shows an estimation range of the distribution of the received power of the reflected wave for each target. The received power of the reflected wave when the distance to the target is defined as a distance r can be calculated by a theoretical received power formula, as expressed by the mathematical formula 5, of a millimeter wave radar using the radar reflection cross section according to the type of the target and the distance r. The distribution of the received power at the ranging point is obtained, for example, by simulation. Here, it is assumed that the distribution of the received power of the ranging point follows a Gaussian distribution centered on the value of the received power when the distance to the target is r. An estimation range Svw2 represents a range that can be estimated as a received power range of a reflected wave reflected by another vehicle. The estimation range Svw2 is calculated by defining the radar cross section σvw2 of the vehicle as 0 dBsm. An estimation range Shm represents a range that can be estimated as a received power range of a reflected wave reflected by a human. The estimation range Shm is calculated by defining the radar cross section σhm of the human as −10 dBsm. An estimation range Ssr15 represents a range that can be estimated as a received power of a reflected wave reflected from a road surface with an inclination of 15 degrees. The estimation range Ssr15 is calculated by defining the radar cross section σsr15 of the road surface with the inclination of 15 degrees as −20 dBsm. An estimation range Ssr0 represents a range that can be estimated as a received power of a reflected wave reflected by a road surface with an inclination of 0 degrees. The estimation range Ssr0 is calculated by defining the radar cross section σsr0 of the road surface with the inclination of 0 degrees as −30 dBsm.

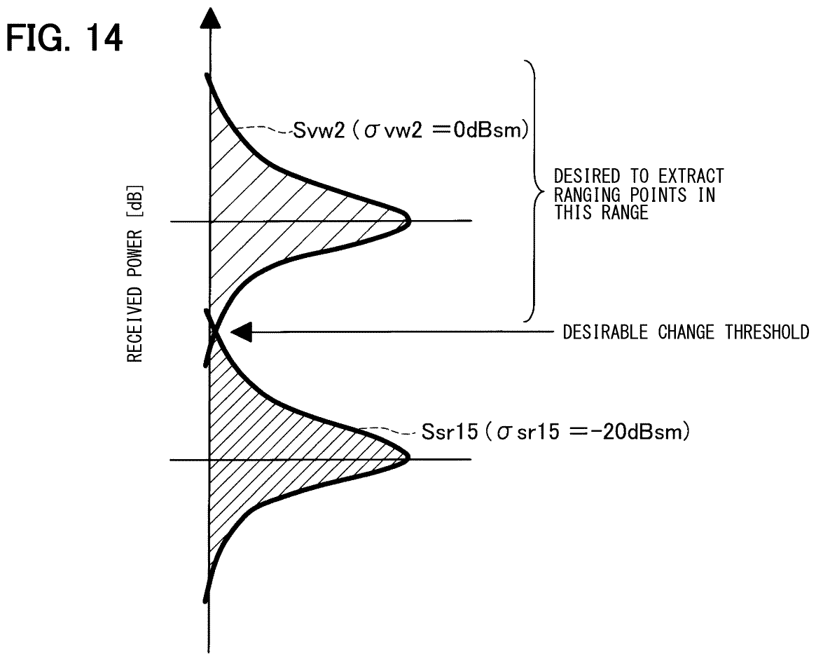

FIG. 14 shows the estimation range Svw2 of the vehicle shown in FIG. 13 and the estimation range Ssr15 of the road surface with the inclination of −15 degrees. In the first embodiment, when the second power threshold value is calculated using the mathematical formula 5, a constant value that is determined in advance according to the type of the target object is used as σ representing the radar cross section. For example, when the type of the target object is a vehicle, the second power threshold value is set to 0 dBsm. When the inclination of the road surface is 0 degrees or close to 0 degrees, that is, when the road surface has almost no inclination, the received power of the radio waves reflected by the road surface is small, so the influence of reflection on the road surface is considered to be small. However, when the road surface has a certain degree of inclination, an erroneous detection may increase due to the influence of reflection on the road surface.

As shown in FIG. 14, when the type of the target object is a vehicle, it is desirable to extract a ranging point cloud based on the reflected waves from the vehicle. For example, it is desirable to set the boundary between the estimation range Svw2 and the estimation range Ssr15 to the change threshold value. In the second embodiment, the second power threshold value is set in consideration of the reflected wave from the road surface so that the distribution range of the received power of the reflected wave from the vehicle can be detected.

In the embodiment described above, when the second power threshold value is calculated, the constant value that is determined in advance depending on the type of the target object is used as σ representing the radar cross section in the mathematical formula 5.

In the second embodiment, σ representing the radar cross section is expressed by the following mathematical formula 6. The radar cross section expressed by the mathematical formula 6 is also referred to as the “corrected radar cross section.” σ1 in the mathematical formula 6 is also referred to as the “first radar cross section.” σ2 in the mathematical formula 6 is also referred to as the “second radar cross section”.

$$\begin{matrix}[ Mathematical Formula 6 ] & \\ & \end{matrix}$$

$$\begin{matrix}[ Math . 6 ] & \\ σ = α \cdot σ1 + ( 1 - α ) \cdot σ2 & ( 6 )\end{matrix}$$

In the mathematical formula 6, α is an arbitrary coefficient having a value in the range of 0<α<1. For example, α is 0.5. When the type of the target object is a vehicle, the radar cross section σvw2 of the vehicle is used as σ1. The radar cross section σsr of the road surface is used as σ2. For example, assumed that α is set to 0.5 (α=0.5). When relations of σ1=σvw2=σ[dBsm] and σ2=σsr=−20 [dBsm] are satisfied, the radar cross section σ calculated using the mathematical formula 6 is −10 [dBsm] (σ=−10).

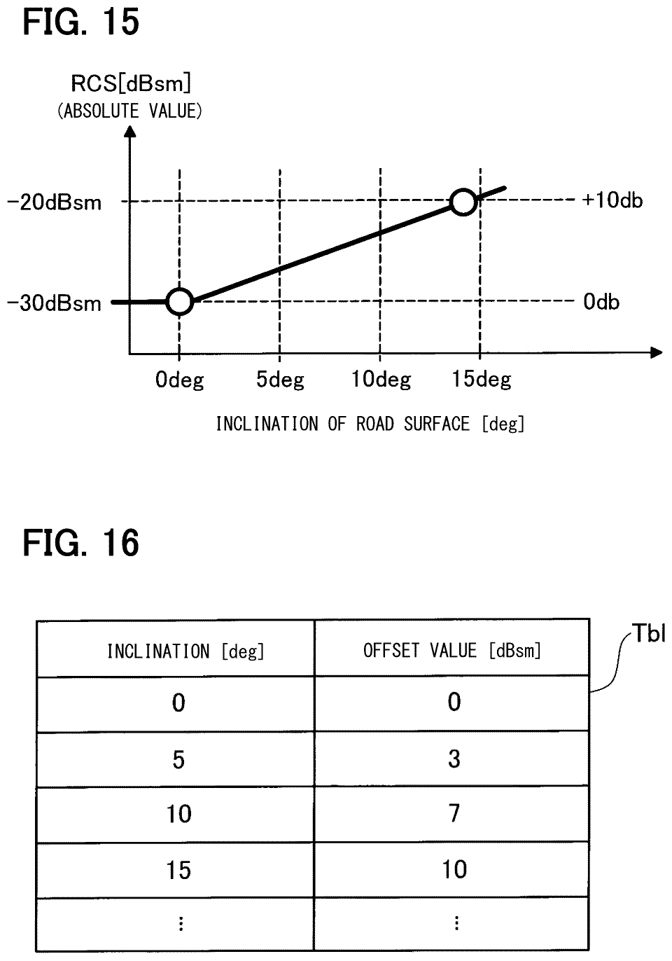

FIG. 15 shows an explanatory diagram illustrating the relationship between the inclination of a road surface and the radar cross section of the road surface as a simple model. The radar cross section of the road surface varies depending on the inclination of the road surface, and the radar cross section of the road surface tends to increase as the inclination of the road surface increases. In the present embodiment, a definition table Tbl as shown in FIG. 16 is prepared in advance, in which offset values of the radar cross section according to the inclination of the road surface are defined. In the definition table Tbl, an absolute value of the radar cross section of the road surface when the inclination of the road surface is 0 degrees is set as a reference value, and a relative value that is a difference between the radar cross section of the road surface of each inclination of the road surface and the reference value is set as an offset value. This is because when the inclination of the road surface is 0 degrees, there is no need to consider the reflection from the road surface. The offset value represents the reflectance of the reflected wave from the road surface. In the present embodiment, the inclination of the road surface refers to a relative inclination relative to the road surface on which the vehicle VW is currently present. Therefore, the inclination of the road surface, the position of the target object and the like are detected based on a coordinate system relative to the vehicle VW (i.e., vehicle coordinate system).

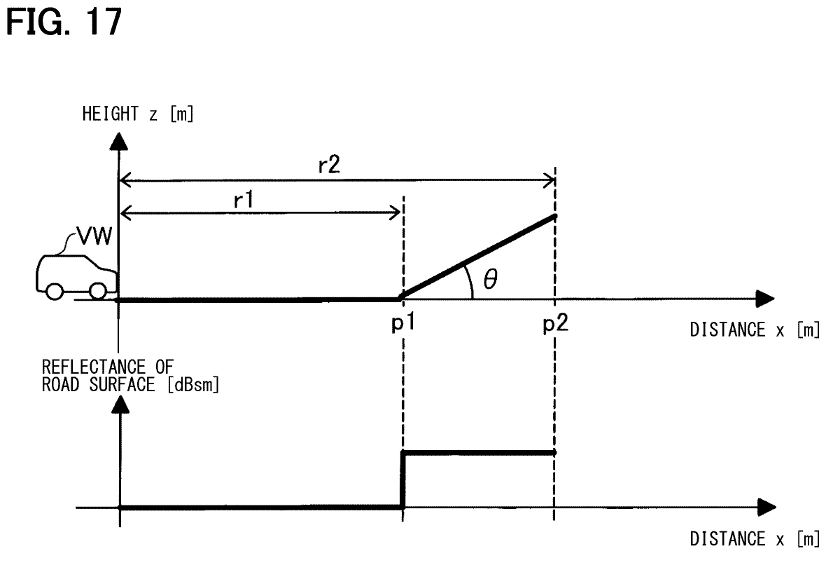

FIG. 17 is a diagram illustrating a method for determining the radar cross section σ2. An upper diagram of FIG. 17 shows an example in which the road surface ahead of the vehicle VW, which is traveling, is inclined. The road surface from the current position of the vehicle VW to a point p1 is flat, that is, the inclination of the road surface is 0 degrees. The point p1 is away from the current position of the vehicle VW by a distance r1. From the point p1 to a point p2, the road surface is inclined at a constant angle θ. The inclination angle θ of the road surface is, for example, 15 degrees. The point p2 is away from the current position of the vehicle VW by a distance r2. The distance r2 corresponds to the detectable distance of the millimeter wave radar 10, for example. Since the detectable distance of the millimeter wave radar 10 is limited, the distance from the current position to the point p2 is considered.

A lower diagram of FIG. 17 shows an explanatory diagram of the radar cross section used as σ2. As shown in FIG. 17, up to the point p1, the offset value of the inclination angle of 0 degrees is obtained from the table Tbl and used as σ2 in the mathematical formula 6. From the point p1 to the point p2, the offset value of the inclination angle of 15 degrees is obtained from the table Tbl and used as σ2 in the mathematical formula 6. In the lower diagram of FIG. 17, the vertical axis represents the reflectance of the road surface. In this case, however, an example in which the offset value of the radar cross section is set is indicated. In this way, in a range from the point p1 at which the inclination begins, the change threshold value considering the inclination is set. The change threshold value is set in each distance. Here, “each distance” refers to each of sections that are defined by sectioning the range from the current position of the vehicle VW to the point P2 into predetermined sections. For example, the length of one section is 1 centimeter. Alternatively, the length of one section may be 5 centimeters. The length of each section may be determined according to the traveling speed of the vehicle VW. In the case where the change threshold value is calculated for each section, σ2 corresponding to the inclination of the road surface of the subject section is used. Since the inclination of the road surface is considered, an occurrence of erroneous detection of a target can be suppressed.

FIG. 17 illustrates an example in which the inclination of the road surface is constant. However, in an actual road, the inclination of the road surface is rarely constant as in FIG. 17. The inclination of the road surface in each section can be determined using known gradient estimation techniques. For example, the gradient estimation techniques described in the following reference literatures 1 to 3 can be used. The following reference literatures 1 to 3 describe techniques for estimating the inclination of a road surface using images captured by a camera.
Reference Literature 1: Li Chen and 10 others, “PersFormer: 3D Lane Detection via Perspective Transformer and the OpenLane Benchmark”, [online], [Retrieved on Mar. 22, 2024], Internet URL: https://arxiv.org./pdf/2203. 11089v3.pdf
Reference Literature 2: Fan Yan and 9 others, “ONCE-3DLanes: Building Monocular 3D Lane Detection”, [online], [Retrieved on Mar. 22, 2024], Internet URL: https://arxiv.org/pdf/2205. σ0301v2.pdf
Reference Literature 3: Noa Garnett and 4 others, “3D-LaneNet: End-to-End 3D Multiple Lane Detection”, [online], [Retrieved on Mar. 22, 2024], Internet URL: https://arxiv.org/pdf/1811. 10203v3.pdf

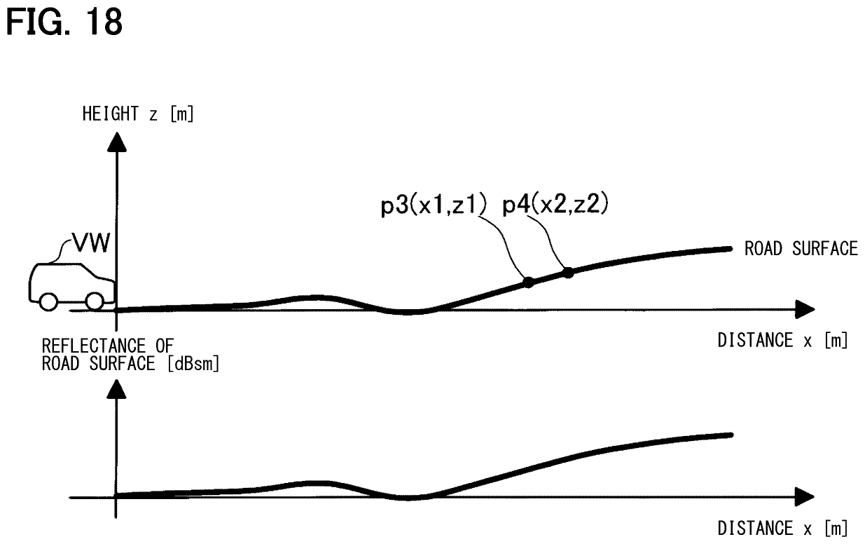

FIG. 18 shows an explanatory diagram of a method for determining the radar cross section σ2. An upper diagram of FIG. 18 shows an example of the inclination of the road surface ahead of the vehicle VW, which is traveling. By using the gradient estimation techniques described above, it is possible to estimate the depth x1 and height z1 of the road surface at any point as viewed from the vehicle VW. The depth x1 indicates the distance from the current position of the vehicle VW to an arbitrary point. The height z1 indicates the height of an arbitrary point relative to the height of the current position of the vehicle VW.

For example, the inclination of the road surface can be calculated by using the depth x1 and the height z1 of any two points. For example, the inclination of the road surface between a point p3 and another point p4 can be calculated using the depth x1 and height z1 at the point p3 and the depth x2 and height z2 at the point p4. The offset value for the section from the point p3 to the point p4 can be determined using the determined inclination and the table Tbl. A lower diagram of FIG. 18 shows the offset value set according to the estimated inclination of the road surface in each section. In the lower diagram of FIG. 18, the vertical axis represents the reflectance of the road surface. In this case, however, an example in which the offset value of the radar cross section is set is indicated. As the inclination of the road surface is rarely constant, it is possible to estimate the inclination of the road surface for a certain range, for example, in front of the vehicle VW traveling, by determining the inclination of the road surface using the known gradient estimation techniques.

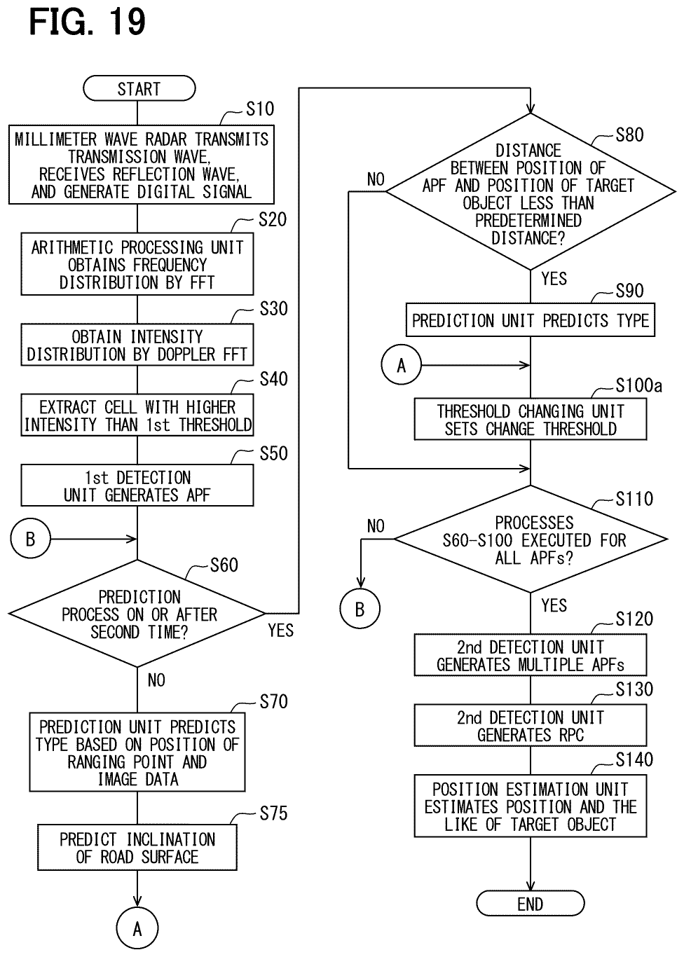

FIG. 19 shows a flowchart illustrating an example of a method for estimating the position of a target object according to the second embodiment. The processing in step S10 to step S70 are similar to those in the example shown in FIG. 9.

In step S75, the prediction unit 146b predicts the inclination of the road surface. The prediction unit 146b estimates the inclination of the road surface based on the image data obtained by the image generation device 20 and using the known gradient estimation technique described above. A predicted inclination information represents the difference in elevation of the road surface in the detection direction of the millimeter wave radar 10 relative to the vehicle VW. More specifically, the predicted inclination information represents the difference in elevation of the road surface of each distance within a certain range in the detection direction of the millimeter wave radar 10. As shown in FIG. 1, the direction of detection of the millimeter wave radar 10 and the direction of detection of the image generation device 20 are assumed to be substantially the same. For example, the inclination of the road surface can be estimated within the range detectable by the millimeter wave radar 10 from the current position of the vehicle VW. The processing of step S75 is also referred to as an “inclination obtaining process step”. The processing in step S80 to step S90 are similar to those in the first embodiment (see FIG. 9).

In step S100a, the threshold changing unit 146c sets the change threshold value. The threshold changing unit 146c sets the change threshold value in the target area TA. The target area TA has the range centered on the cell having the greater intensity than the first power threshold value, as shown in FIG. 4, and is the range corresponding to the dimension according to the type of the target object.

The threshold changing unit 146c determines an offset value for each distance by using the determined inclination and the table Tbl. Here, the offset value for each distance is shown as a grid-like cell in FIG. 4. Alternatively, the offset value may be an offset value corresponding to the interval of the grid in the direction along the distance. The determined offset value is also referred to as the “correction value”. The offset value is used as σ2 in the mathematical formula 6. The threshold changing unit 146c calculates the radar cross section σ, which is used to calculate the second power threshold value, by using the mathematical formula 6 described above. Here, the radar cross section σ is calculated for each distance from the vehicle VW within the range of the target area TA1. The radar cross section σvw2 of the vehicle is used for σ1, and the radar cross section σsr of the road surface is used for σ2. The radar cross section σvw2 of the vehicle has a constant value. The radar cross section σsr of the road surface is an offset value according to the inclination. The radar cross section σsr of the road surface is determined according to the inclination of the road surface estimated in step S75. This is because, as shown in the upper diagram of FIG. 18, the inclination of the road surface on which the vehicle VW travels is not constant in general. As the radar cross section σsr of the road surface depending on the gradient of the distance, the offset value set depending on the inclination of the road surface estimated for each distance, as shown in the lower diagram of FIG. 18, is used. More specifically, in the range of the road surface corresponding to the range of the target area TA, the offset value that is set according to the inclination of the road surface is used as the radar cross section σsr. The radar cross section σ calculated using the mathematical formula 6 described above is a value obtained by adjusting the change value of the radar cross section according to the type of the target object with the reflectance of the reflected wave reflected by the road surface. In step S100a, the radar cross section σ calculated is configured as an array including a plurality of values (hereinafter referred to as a radar cross section group).

Next, the threshold changing unit 146c calculates the reception power Pr of the millimeter wave radar 10 as a third power threshold value using the mathematical formula 5. Since the radar cross section σsr of the road surface varies depending on the distance from the current position of the vehicle VW, the third power threshold value is calculated according to the distance from the current position of the millimeter wave radar 10. From the current position of the vehicle VW (i.e., the millimeter wave radar 10), the third power threshold value is calculated for each distance from the current position of the vehicle VW. In step S100a, the calculated third power threshold value is configured as an array including a plurality of received power values (hereinafter, referred to as a third power threshold group). The threshold changing unit 146c sets the change threshold value within the range of the target area TA using the third power threshold group. Specifically, the change threshold is set by the value that is obtained by increasing or decreasing the value of the received power included in the third power threshold group by a determined value within the range of the target area TA. For example, if the target object is an inanimate object, including a vehicle, the determined value may be any value within the range of −5 dBsm to +5 dBsm. The target area TA is a range Wm centered on the cell A extracted by the constant false alarm rate processing described in the above embodiment. The threshold value for the range outside the target area TA is set to the third power threshold value. Alternatively, the threshold value for the range outside the target area TA may be set to the second power threshold value, as in the first embodiment.

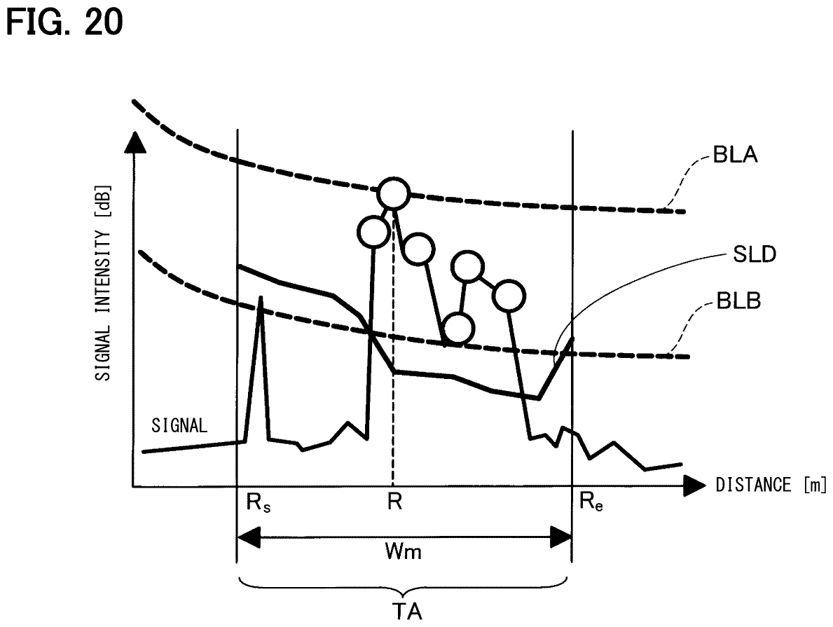

FIG. 20 shows the change threshold value that has been set. In FIG. 20, the change threshold value is shown by the solid line SLD. The dashed line BLA represents the second power threshold value as described in the first embodiment. The dashed line BLB represents the second power threshold value that is shifted by a certain amount. In FIG. 20, circles represent cells. In FIG. 20, illustration of the threshold values for the range other than the target area TA are omitted. The processing of step S100a is also referred to as a “correction value obtaining process”. The processing of step S100a is also referred to as a “threshold changing process”.

The processing of step S110 and after are similar to those in the embodiment described above.

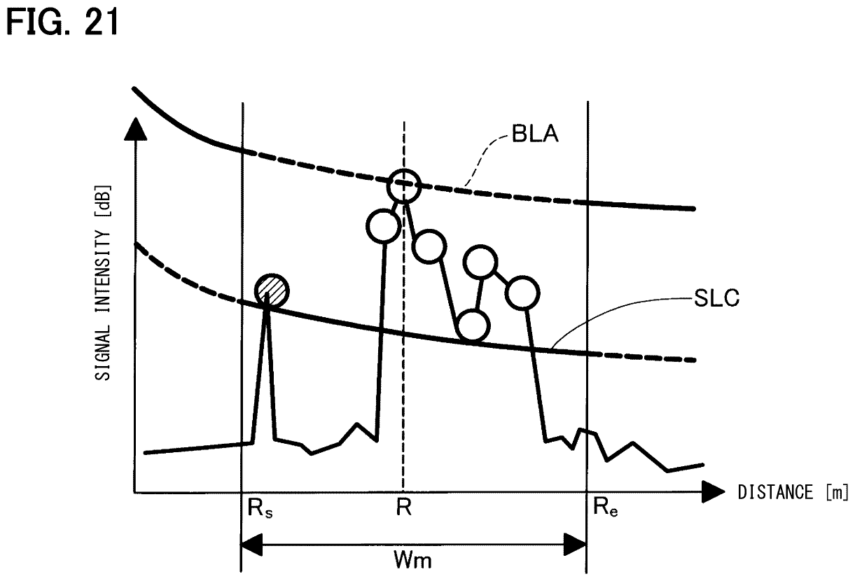

FIG. 21 is a diagram for explaining the advantages of the method for setting the change threshold value according to the second embodiment. FIG. 21 shows an example in which the change threshold value is set by the method according to the first embodiment. In FIG. 21, circles represent the cells. The example shown in FIG. 21 shows the reception strength of the reflected wave when the road surface has an inclination. The cell indicated by a hatched circle represents a reflected wave reflected by the inclination of the road surface. In the illustrated example, the reception intensity of the reflected wave reflected by the inclination of the road surface exceeds the change threshold value. As a result, there is a risk that a target will be erroneously detected at a position calculated based on the cell represented by the hatched circle.

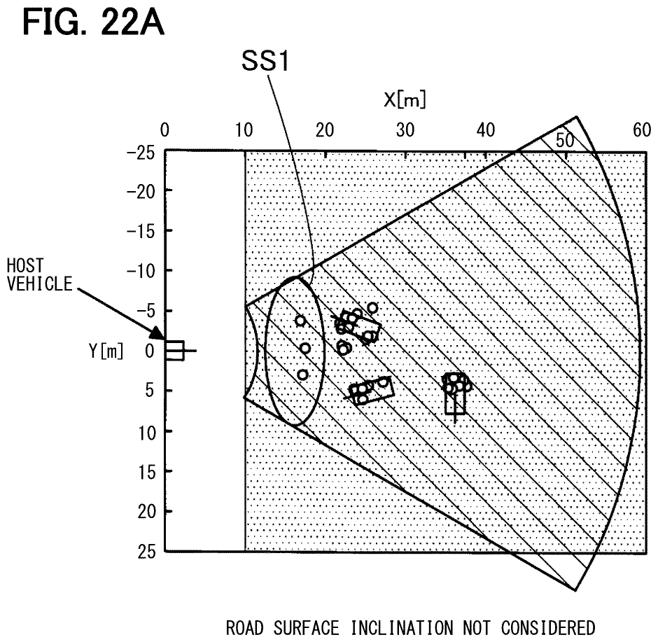

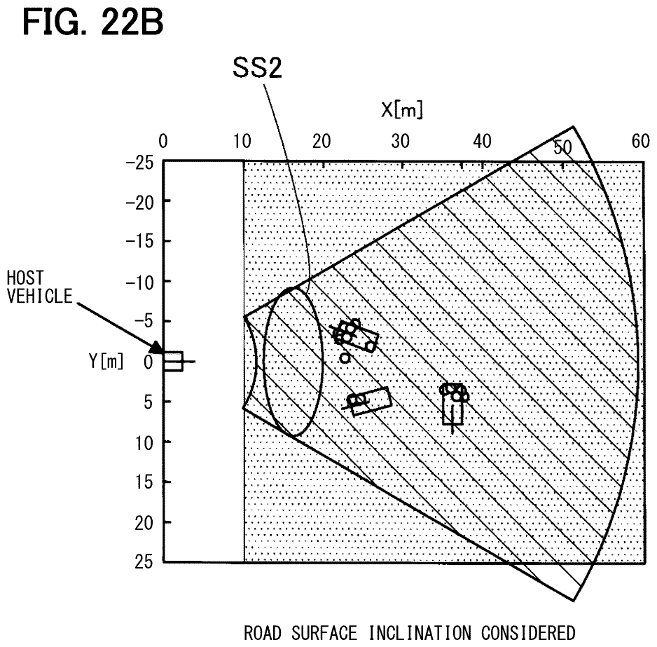

FIGS. 22A and 22B each shows an example of a ranging point cloud detected by the vehicle VW (host vehicle). FIGS. 22A and 22B show the vehicles VW viewed from above. An area hatched with oblique lines represents the range detectable by the millimeter wave radar 10 provided in the vehicle. Also, an area hatched with dots represents the range where the road surface is inclined at a certain angle. Circles represent ranging point clouds. FIG. 22A shows an example of the ranging point clouds detected when the change threshold value is set by the method of the first embodiment described above. As shown in FIG. 22A, when the inclination of the road surface is not considered, that is, when the change threshold value is set using the method according to the embodiment described above, multiple ranging point clouds are detected in a range SS1 in front of the vehicle. Although the vehicle VW is currently present on the flat road surface, the ranging point clouds are detected based on the reflected waves reflected by the inclination of the road surface ahead of the vehicle VW. In this case, there is a risk that a target will be erroneously detected at a position calculated based on the cell represented by the hatched circle.

On the other hand, in the second embodiment, as shown in FIG. 20, the change threshold value is set using the radar cross section (the corrected radar cross section) that is calculated using the mathematical formula 6 with consideration of the inclination of the road surface. Since the inclination of the road surface is taken into consideration when detecting a target, the occurrence of erroneous detection of the target can be suppressed.

FIG. 22B shows an example of the ranging point clouds detected when the change threshold value is set by the method of the second embodiment. As shown in FIG. 22B, when the change threshold value is set by the method of the second embodiment in which the inclination of the road surface is considered, no ranging point cloud is detected in a range SS2 in front of the vehicle. In this way, since the inclination of the road surface is taken into consideration when detecting a target, the occurrence of erroneous detection of the target can be suppressed.

An arbitrary value can be set to a in the mathematical formula 6. For example, a may be changed depending on the weather. Radar waves tend to be attenuated by rainfall. When it is raining, the influence of reflection on the road surface is thought to be smaller than that when it is not raining. For this reason, different values can be used as the coefficient (1−a) of σ2 in the mathematical formula 6 depending on whether it is raining or not. The value of the coefficient (1−a) used when it is raining may be set to be smaller than the value of the coefficient (1−a) used when it is not raining. Whether or not it is raining can be determined based on the detection result of a raindrop sensor provided in the vehicle VW, for example.

C. Other embodiments: C1. Alternative embodiment 1: (1) In the embodiments described above, the target object position estimation device 1 is installed in the vehicle VW. The vehicle may be equipped with an advanced driver assistance system or may be capable of performing autonomous driving. In such configurations, the control unit that receives a signal to stop the vehicle may automatically stop the vehicle. Note that the target object position estimation device may be installed in a moving body other than the vehicle, such as a ship or an aircraft.

(2) In the embodiments described above, the CPU 146 functions as the first detection unit 146a, the prediction unit 146b, the threshold changing unit 146c, and the second detection unit 146d. Note that some or all of the functions of the first detection unit, the prediction unit, the threshold changing unit, and the second detection unit may be realized by hardware circuit(s).

(3) In the embodiments described above, when the type of the target object predicted by the prediction unit 146b is a car, the average of the overall lengths of multiple types of cars is stored as the car dimension in the storage unit 141. For example, the car dimension may be the average overall width of multiple types of cars, and can be set arbitrarily by a manufacturer or a worker.

(4) In the embodiments described above, after the power supply of the vehicle VW is turned on, the image generation device 20 generates image data successively with a predetermined time difference of one second. The image generation device 20 may generate the image data with a time difference other than one second, such as 0.1 seconds or 5 seconds. Further, the interval at which processing is performed may be other than 3 seconds, such as 1 second or 5 seconds.

(5) In the embodiments described above, two cells A and B are extracted in the first detection process, and two ranging points are generated based on the respective cells. For example, in the first detection process, one cell may be extracted.

(6) For example, of the two successive transmission waves in step S20 executed again, the transmission wave that is emitted from the transmitter at an earlier time may be the transmission wave that was emitted from the transmitter in step S20 of the previous processing. That is, in step S20 executed again, the arithmetic processing unit of the signal processing unit generates a digital signal based on the transmission wave that was emitted from the transmitter as a later one of the two successive transmission waves, and performs the Doppler FFT on the one to obtain the frequency distribution, which is the distribution representing frequency and intensity. Then, in step S20, the arithmetic processing unit may obtain the frequency distribution for two successive transmission waves in combination with the frequency distribution that was obtained in step S20 of the previous processing cycle based on the transmission wave emitted from the transmitter at the earlier timing. Alternatively, the Doppler FFT may be performed on five frequency distributions corresponding to, for example, five successive transmission waves other than two successive transmission waves.

(7) In the embodiments described above, the position of the ranging point APF relative to the millimeter wave radar 10 is estimated by using MUSIC, which is the orientation estimation algorithm. As the orientation estimation algorithm, CAPON, DBF, or ESPRIT may be used.

(8) In the embodiments described above, the first ranging point APF1 and the second ranging point APF2 generated in the first detection process are both included in one ranging point cloud RPC generated in the second detection process. For example, the multiple ranging points generated in the first detection process may belong to different ranging point clouds.

C2. Alternative embodiment 2: (1) In the embodiments described above, in the target object position estimation process, the size, type, orientation, and velocity of the target object are estimated. For example, in the target object position estimation process, one of or two or more of the size, type, orientation, and velocity of the target object may be estimated. Alternatively, in the target object position estimation process, the size, type, orientation, and velocity of the target object may not be estimated.

(2) In the embodiments described above, information about the target object estimated in the target object position estimation process is stored in the storage device. For example, the storage device may store only the type of the target object for use in the prediction process performed on the second or subsequent time. For example, in a configuration in which the first method described above is executed in the prediction process on the second or subsequent time, the storage device may not store the type of the target object.

C3. Alternative embodiment 3: (1) In the embodiments described above, cells are extracted by performing the constant false alarm rate processing in the first detection process. For example, in the first detection process, cells may be extracted using a threshold value that is set in advance and does not change with distance. In this configuration, the threshold value is defined to the value at which a cell based on a received signal reflected from either animate or inanimate objects is extracted.

(2) In the embodiments described above, the two-dimensional constant false alarm rate processing is performed in the first detection process. Alternatively, in the first detection process, a one-dimensional constant false alarm rate processing may be performed.

(3) In the embodiments described above, in the first detection process, the threshold value which enables detection of both living objects, such as pedestrians and animals, and inanimate objects, such as other vehicles, buildings, and traffic lights, is determined. The arithmetic processing unit may change the threshold value in the first detection process depending on, for example, the environment in which the vehicle is traveling. For example, on expressways, a threshold value which enables detection of other vehicles may be set. On general roads, a threshold value which enables detection of both living object and inanimate objects may be set.

C4. Alternative embodiment 4:

In the embodiments described above, the first method described above is executed in the prediction process on the first time, and the second method described above is executed in the prediction process on the second or subsequent time. For example, the first method may be executed in the prediction process on the second or subsequent time as well.

C5. Alternative embodiment 5: (1) In the embodiments described above, in the threshold changing process, the threshold changing unit 146c calculates the second power threshold value and the change threshold value using the reception power theoretical formula for the millimeter wave radar 10. For example, in the threshold changing process, the intensity of the received power expected for each distance relative to the millimeter wave radar, which is calculated in advance, may be set as the change threshold value.

(2) In the embodiments described above, the second power threshold value is set for the range other than the target area TA in the threshold changing process. For example, in the threshold changing process, the first power threshold value set in the first detection process may be set in a range other than the target area TA.

(3) In the embodiments described above, the radar cross section used in the mathematical formula is the value changed from a predetermined value depending on the type of the target object, and the changed value is a value within the range of −5 dBsm to +5 dBsm when the target object is an inanimate object including a vehicle, and a value within the range of −15 dBsm to −5 dBsm when the target object is a living object. Alternatively, the changed value may be outside the range of −5 dBsm to +5 dBsm and equal to or less than 20 dBsm when the target object is a vehicle, and may be outside the range of −15 dBsm to −5 dBsm and equal to or less than 0 dBsm if the target object is a living object.

C6. Alternative embodiment 6: (1) In the embodiments described above, the storage unit 141 stores the position relative to the millimeter wave radar 10, the velocity and the intensity of the received power of the reflected waves RW, of each of the multiple ranging points APF generated in the first detection process and the second detection process. For example, the storage unit may store one or two of the position relative to the millimeter wave radar, the velocity and the intensity of the received power of the reflected wave of each of the multiple ranging points.

(2) For example, the storage unit may store information on the ranging points generated in either the first detection process or the second detection process.

C7. Alternative embodiment 7: (1) In the embodiments described above, in the target object position estimation process, the three-dimensional position relative to the millimeter wave radar 10, orientation, size, and velocity of the ranging point cloud RPC composed of the multiple ranging points APF are calculated. For example, in the target object position estimation process, any one or two of the three-dimensional position relative to the millimeter wave radar, orientation, size, and velocity of a ranging point cloud composed of the multiple ranging points may be calculated.

(2) In the embodiments described above, the second detection unit 146d generates the three-dimensional ranging point cloud RPC that indicates the height relative to the millimeter wave radar 10. For example, the second detection unit may generate a two-dimensional ranging point cloud relative to the millimeter wave radar.

C8. Alternative embodiment 8: In the target object position estimation process, information on the target object may be estimated using an algorithm that is any one or a combination of two or more of clustering, tracking processing, HOG, and SIFT, or a method other than a machine learning algorithm. For example, when a test is performed at a testing site using a target object position estimation device, information on the target object may be estimated by an operator.

C9. Alternative embodiment 9: For example, the position of a target object may be estimated by a program that executes the target object position estimation method described above.

C10. Alternative embodiment 10: In the second embodiment, the example in which the offset value is defined in the definition table Tbl has been indicated. Alternatively, the absolute value of the radar cross section, instead of the offset value, may be defined in the definition table Tbl. Moreover, instead of the definition table Tbl, a function that defines the correspondence between the angle of inclination of the road surface and the intensity of the reflected wave from the road surface may be used.

C11. Other embodiment 11: In the second embodiment, the example in which the inclination of the road surface is estimated using the known gradient estimation technique based on image data has been indicated. Alternatively, the inclination of the road surface may be estimated using the detection results of the millimeter wave radar 10. In such a case, a three-dimensional radar is used as the millimeter wave radar 10.

The present disclosure should not be limited to the embodiments or modifications described above, and various other embodiments may be implemented without departing from the scope of the present disclosure. For example, the technical features in each embodiment corresponding to the technical features in the form described in the summary may be used to solve some or all of the above-described problems, or to provide one of the above-described effects. In order to achieve a part or all of the above-described effects, replacement or combination can be appropriately performed. In addition, as long as a technical feature is not described as essential in the present specification, the technical feature may be omitted as appropriate.

1. A method for estimating a position of a target object, the method comprising:
obtaining frequency distributions each representing a frequency and an intensity for at least two successive transmission waves by performing a fast Fourier transform (FFT) on digital signals, the digital signals being obtained based on reception signals caused by receiving reflected waves of modulated transmission waves transmitted from a millimeter wave radar and reflected by a target object;
obtaining an intensity distribution representing an intensity on a cell of a combination of a distance relative to a position of the millimeter wave radar and a velocity by performing a Doppler FFT on at least two of the frequency distributions corresponding to the at least two successive transmission waves;
generating at least one ranging point representing a position relative to the position of the millimeter wave radar, based on at least one cell extracted from the intensity distribution and having an intensity greater than a predetermined threshold value;
predicting a type of the target object to which the ranging point belongs based on an image data including the target object and obtained by an image generation device;
setting a change threshold value, for the at least one cell extracted, in a predetermined target area having a range that includes the at least one cell of the intensity distribution and is determined based on the predicted type of the target object;
generating a plurality of ranging points representing positions relative to the position of the millimeter wave radar, based on a plurality of cells extracted in the target area and representing intensities greater than the change threshold value; and
estimating the position of the target object relative to the position of the millimeter wave radar based on the plurality of ranging points.

2. The method for estimating the position of the target object according to claim 1, wherein
the estimating the position of the target object further includes estimating one or more of a size, a type, an orientation, and a velocity of the target object, based on the estimated position of the target object and the image data including the target object and obtained by the image generation device, the method further comprising:
storing estimated information in a storage device.

3. The method for estimating the position of the target object according to claim 1, wherein
the generating the at least one ranging point includes performing a constant false alarm rate processing on the intensity distribution to extract the at least one cell having the intensity greater than the predetermined threshold value.

4. The method for estimating the position of the target object according to claim 2, wherein
the estimating the position of the target object includes estimating at least a type of the target object,
the predicting includes a first predicting, which is performed on a first time, of predicting the type of the target object based on the position of the at least one ranging point relative to the position of the millimeter wave radar and the image data,
the predicting includes a second predicting, which is performed on a second or subsequent time, of predicting the type of the target object predicted in a previous processing as the type of the target object to which the at least one ranging point belongs when the position of the at least one ranging point relative to the position of the millimeter wave radar and the position of the target object estimated in the previous processing are located closer to each other than a predetermined distance, and
a processing is terminated when the position of the at least one ranging point relative to the position of the millimeter wave radar and the position of the target object estimated in the previous processing are not located closer to each other than the predetermined distance.

5. The method for estimating the position of the target object according to claim 1, wherein
the setting the change threshold value includes calculating an intensity of power of the reflected wave as the change threshold value, the intensity of power of the reflected wave being calculated by a following mathematical formula 7,
$$\begin{matrix}[ Mathematical Formula 7 ] & \\ & \end{matrix}$$
$$\begin{matrix}[ Math . 7 ] & \\ {P}_{r} = \frac{{P}_{t} {G}^{2} {λ}^{2} σ}{{( 4 π )}^{3} \cdot {R}^{4}} & ( 7 )\end{matrix}$$
in which a radar cross section has a value changed from a predetermined value according to the type of the target object, and
wherein the value changed is in a range from −5 dBsm to +5 dBsm when the target object is a vehicle, and in a range from −15 dBsm to −5 dBsm when the target object is a living object.

6. The method for estimating the position of the target object according to claim 1, further comprising:
storing information in a storage unit, the information indicating one or more of the position relative to the position of the millimeter wave radar, a velocity, and an intensity of a received power of the reflected wave of each of the plurality of ranging points generated in the generating the plurality of ranging points.

7. The method for estimating the position of the target object according to claim 1, wherein
the generating the plurality of ranging points includes calculating one or more of a three-dimensional position relative to the millimeter wave radar, an orientation, a size and a velocity of a ranging point cloud composed of the plurality of ranging points.

8. The method for estimating the position of the target object according to claim 1, wherein
the estimating the position of the target object uses an algorithm that is one of or a combination of two or more of clustering, tracking, HOG, and SIFT, or a machine learning algorithm.

9. The method for estimating the position of the target object according to claim 1, further comprising:
after the predicting, obtaining inclination information indicating an inclination of a road surface on which a moving body equipped with the millimeter wave radar and the image generation device is traveling in a predetermined detection direction of the millimeter wave radar and the image generation device; and
obtaining a correction value considering the inclination of the road surface for each distance in the detection direction, using the inclination information and a definition table or a function that predefines a correspondence between an angle of the inclination of the road surface and the intensity of the reflected wave, wherein
the setting the change threshold value sets the change threshold value using the correction value.

10. The method for estimating the position of the target object according to claim 9, wherein
the obtaining the inclination information obtains the inclination information using one or more of the at least one ranging point and the image data obtained by the image generation device.

11. The method for estimating the position of the target object according to claim 10, wherein
the obtaining the inclination information obtains, as the inclination information, a difference in elevation of the road surface relative to the moving body for each distance.

12. The method for estimating the position of the target object according to claim 11, wherein
the obtaining the correction value includes obtaining a first radar cross section that is predetermined according to the type of the target object and a second radar cross section that is a radar cross section of the road surface according to the inclination, and
the obtaining the correction value includes obtaining a corrected radar cross section for each distance using the first radar cross section and the second radar cross section.

13. A non-transitory computer readable medium storing a computer program product comprising instructions configured to, when executed by a computer, cause the computer to execute the method according to claim 1.

14. A target object position estimation device, which is a millimeter wave radar that transmits a modulated transmission wave, the target object position estimation device comprising:
an arithmetic processing unit configured to
obtain frequency distributions each representing a frequency and an intensity for at least two successive transmission waves by performing a fast Fourier transform (FFT) on digital signals that are obtained based on reception signals caused by receiving reflected waves of modulated transmission waves transmitted from the millimeter wave radar and reflected by a target object, and
obtain an intensity distribution representing an intensity on a cell of a combination of a distance relative to a position of the millimeter wave radar and a velocity by performing a Doppler FFT on at least two frequency distributions corresponding to the at least two successive transmission waves;
a first detection unit configured to generate at least one ranging point representing a position relative to the position of the millimeter wave radar based on the cell in the intensity distribution and having an intensity greater than a predetermined threshold value;
a prediction unit configured to predict a type of the target object to which the at least one ranging point belongs based on an image data obtained by an image generation unit and including the target object;
a threshold changing unit configured to set a change threshold value, for the at least one cell extracted, in a target area having a range that is determined based on the predicted type of the target object and including the cell in the intensity distribution;
a second detection unit configured to extract a plurality of cells having greater intensities than the change threshold value in the target area and to generate a plurality of ranging points representing positions relative to the position of the millimeter wave radar based on the plurality of cells; and
a position estimation unit configured to estimate the position of the target object relative to the position of the millimeter wave radar based on the plurality of ranging points.
